(19) United States
(12) Patent Application Publication
(10) Pub. No.: US 2008/0309816 A1
(43) Pub. Date: Dec. 18, 2008

(54) TELEVISION CONTENT CONTROL SYSTEM AND METHOD WITH CROSS-PLATFORM CAPABILITY

(75) Inventors: Ronald Quan, Cupertino, CA (US); John Cloutman, Tracy, CA (US)

Correspondence Address: MORRISON & FOERSTER LLP, 755 PAGE MILL RD, PALO ALTO, CA, 94304-1018, US

(73) Assignee: Macrovision Corporation, Santa Clara, CA (US)

(21) Appl. No.: 12/132,493

(22) Filed: Jun. 3, 2008

Related U.S. Application Data
(60) Provisional application No. 60/934,723, filed on Jun. 15, 2007.

(51) Int. Cl. H04N 7/01

(52) U.S. Cl. 348/441; 348/E07.001

(57) ABSTRACT

Method and apparatus for content control of television signals which operate over multiple television standards and include flags, control bits, data copy, copy protection signals and/or video modification signals. Content control for high definition television signals is provided operative with television-type devices, such as television transmitters, signal translators, recorders, players and others. This approach to content control is intended to operate both with the legacy analog television standards and new higher definition television standards, including the various HDTV standards to convert and detect content control information for use across standards. Thus this provides a multiple standard definition television content control apparatus and method with cross-platform capabilities

### CROSS-REFERENCE TO RELATED APPLICATION

This application claims priority to U.S. provisional application No. 60/934,723 filed Jun. 15, 2007, and incorporated herein by reference in its entirety.

### FIELD OF THE INVENTION

This disclosure relates to video and television (TV) and more specifically to content management of TV and video signals.

### BACKGROUND OF THE INVENTION

Content management or content control is well known in the information field, and generally refers to controlling use of audio and video material. Often such content control involves modifying a digital video signal to include tags or trigger bits or flags which define how the material can be used by various downstream devices. One aspect of content management is copy protection, typically carried out in the analog domain. Generally copy protection refers to methods and apparatus for processing a video signal to inhibit making of acceptable video recordings and is also referred to here as anticopy process (ACP).

The broader field of content control includes use of so called compliant devices that are designed to include circuitry or software that detects certain predetermined signals (or the absence of same) in a received video signal. The presence (or absence) of the particular signal is interpreted as a command to the receiving device to enable or inhibit recording, for instance, or storage or further transmission. In some cases, this control involves generational copy management where a first generation copy may be made, but subsequent generation copies are prevented. Such copy management is applicable to digital video signals of the types used on video media, such as DVDs and also other types of television signals, including high definition television. These more sophisticated copy control systems typically require dedicated circuitry and/or software in the receiving device to detect and interpret special data provided in the video signal for purposes of content management.

US 2006/0093140 A1, inventor Ronald QUAN and entitled Content Management for High Definition Television and incorporated here by reference in its entirety, is directed to content management in the realm of high definition television video signals using tri-level sync pulses and is incorporated herein by reference in its entirety. High definition (HD) television is a well-defined video standard. However typically in the video field television signals are processed between devices which do not necessarily adhere to the same television standard and/or which may be receiving signals in different television standards. (Television is a type of video, adapted for transmission over the air, by cable, or by satellite.) Television standards refer to both the well-known so-called legacy television standards which has been around for a long time and generally operating in the analog domain, including NTSC, PAL, SECAM, VGA and others. Also included are the various newer digital television standards, including the 720p standard which provides a picture with 720 vertical lines each with 1,280 pixels horizontally. The p refers to progressive scanning as used in computer displays. HDTV (high definition television) is replacing analog standard (NTSC in the United States) television. Somewhat different HDTV formats are being adopted by different countries and groups of countries typically using different frame rates, as is the case with legacy television. Digital TV (DTV) here refers to particular television formats and is not necessarily the same as so-called digital cable television. Digital TV (in this sense, actually digital broadcast television) actually defines (in the U.S.) eighteen different formats for broadcast television in digital format. Currently, HDTV represents at least six of those eighteen formats.

### SUMMARY

The present inventors have identified a need to provide a content control system usable for multiple TV standards and that is operative with the conventional content management information such as flags, control bits, data, copy protection signal(s), and/or modification signals. In particular, content control (including copy control also referred to here as copy protection) for high definition TV signals is needed in future TV devices such as TV transmitters, signal translators, recorders, players, displays, or the like. Because there is also a need to accommodate “legacy” TV standards such as 240p, NTSC, PAL, SECAM, VGA, etc., a new content control system is needed to combine the legacy standards with newer TV higher definition standards such as 720p, 1080i, 1080p, etc. for content control.

Currently available TV/video circuits and sets accommodate various TV resolutions (standards), and also tailor each TV standard with specific or programmable copy/content signal(s). What is used in terms of copy/content control with a composite TV signal such as NTSC or PAL, may not be applicable directly to an RGB or component video waveform. For example, a color stripe subcarrier signal for copy control is applicable to NTSC or PAL TV, but not applicable to a component TV/video waveform that lacks a subcarrier signal. One embodiment operates with various TV standards for high definition TV. By mapping from one TV standard's copy/content control signal(s) to another, a cross platform system is achieved.

Copy/content control across various platforms with differing TV resolutions may be implemented by reception of a transmitted signal such as via fiber, satellite, Internet, cable, or phone lines (DSL or dial up) to receive data or programming information to configure copy/content control signals for different TV standards including HDTV. One can also store the configuration information via media and/or memory (e.g., solid state, magnetic, and/or optical), and use the stored configuration information to program the copy/content control signal across many TV standards. Thus, the configuration (of copy/content control signals and/or detection of such signals for multiple resolutions) is changeable or can be updated.

A goal of mapping copy/content control signals across different TV standards is to add security to the control system. A secure control system does not allow for a “loophole” so that all standards have some type of recognizable control signal, such that conversion to another standard is limited or prohibited or, is forced to output the converted video signal with an added copy/content control signal.

One embodiment of the invention encodes or modifies video signals conforming to one or a plurality of HD (high definition) TV standards. TV signals conforming to each standard may include one or more modifications to a portion of the HD signal. For example, each HDTV standard may have its own type of modification or a modification that is in common with another HDTV standard.

Another embodiment is an apparatus or method for providing, generating, synthesizing, or processing a tri-level sync (synchronization) video signal into a video signal with modified levels in a portion of the tri-level sync video signal (e.g., which may combined with specific copy/content control bits) for at least one HDTV standard (e.g., TV is a combined video and audio signal.)

Another embodiment is an apparatus that provides a high definition copy/content control signal along with a providing a standard definition copy protection signal and/or standard definition content control signal.

Another embodiment is a reader or detector, which senses, reads, or detects a standard definition video signal with content control or copy protection signals along with the capability to detect modifications on an HD video signal. For example, this may be a detector or reader device or software program that is capable of detecting signal modifications in SD and/or HD. The reader or detector may be imbedded in a particular device or circuit.

Yet another embodiment is a digital TV tuner, device, and/or receiver, which receives DTV (digital television) in the form of HDTV and/or SDTV, and/or includes a converter for producing a scaled analog and/or digital signal, which includes generating copy protection, data, and/or content control signal(s) for one or more analog and digital TV output. (Note that such video signal conversions, without the content/copy control aspect, are routine in the field.) One example includes generation of a modified HDTV signal with the capability of adding one or more copy control signals in the SDTV standard. For example, a modified HDTV (and/or SDTV) type signal may include modified sync pulses, conventional AGC (Automatic Gain Control) pulses, a data signal added to an overscan area, raised or lowered portion in an overscan area of a TV picture, and/or conventional pseudo sync pulses. For example, reading or sensing any of the modification(s) in the HDTV signal may result in a subsequent modification in a SD video signal. Such video conversion is routine and is done by up sampling or down sampling of TV lines and fields. Commercially available products such as certain DVD players do this.

The tuner, device, and/or receiver may for example, process signals that include RF modulated signals complying to the U.S.A.'s FCC or international broadcast specifications for “off air” broadcasting for analog and/or digital RF signals (e.g., vestigial AM, quadrature AM, DTV, ATSC, multilevel VSB, QAM multi-bit, PSK, AM, WiFi, WiMax, and/or FM) along with analog NTSC or equivalent composite video signals, computer component video signals, component vide signals, digital signals such as HDMI, SDI, DVI, USB, and/or Firewire.

In one embodiment, the detector outputs a signal indicative (or a signal lacking the presence) of a content control signal modification in SD and/or HD. This output signal may or may not be used later on. For example, upon detection of a modification, an output or input video signal may be modified, shut down, or recorded in a particular manner (e.g., not able to record, record for a particular time period, recorded with added content control or copy protection signal, recorded with a different resolution, or the like).

Another embodiment is an apparatus wherein one or more input analog and/or digital TV signal(s) are coupled into the apparatus and wherein one or more video signal output(s) are output from the device. This device may receive a modified input video signal (e.g., containing one or more content control signals and/or at least part of a copy protection signal of one standard to couple/provide a content control signal and/or at least part of a copy protection signal of another standard.) For example, an analog and/or video signal for HD is coupled to the input of such a device (e.g., transcoder, A/D and/or D/A, cross platform standards converter, etc.) with a modification may yield a modification to an SD (or HD or digital) signal for one or more outputs (or vice versa).

The content control modification may include any combination of: one or more positive going pulses, one or more negative going pulses, a data signal, one or more incorrect color signals, level shifting (e.g., positive and/or negative level shifting) in a portion of the video signal, one or more sync pulse modifications (e.g., position, pulse-width, and/or amplitude), added signal(s) to at least a portion of the vertical and/or horizontal blanking interval(s), modified color burst of at least one cycle of incorrect phase and/or frequency, modulated signal that is added/inserted in a portion of the video signal (wherein the modulated signal may include any combination of quadrature modulation, AM, FM, frequency hopping, PCM, PWM, PPM, spread spectrum modulation, PSK, BPSK, FSK, BFSK, and/or the like), which may be including one or more control bits, one or more configuration bits, and/or the like.

Another embodiment includes in the realm of copy protection various TV horizontal blanking interval signal back porch (or front porch) modifications to one or more HD TV standards. These HD modifications may include any number or series of positive and/or negative going pulses/signals in the TV signal back porch in addition to and/or in place of the back porch pulses. For example, one or more HD back porch pulses (or HD pseudo sync signal(s)) may be used for detection by a reader, and/or for encoding for downstream content control purposes.

### BRIEF DESCRIPTION OF THE FIGURES

FIG. 1 shows a reader apparatus.

FIG. 2A shows an encoder or modifier.

FIG. 2B shows a generator or signal provider.

FIG. 2C shows a scaler or transcoder.

FIG. 3 shows a modifier.

FIG. 4 shows a circuit, device, apparatus, and/or software.

FIG. 5 shows signals and/or modification to a signal.

FIG. 6 shows waveform modifications to one or more HD signal(s).

FIGS. 7A-7G and 8A-8E and 9 show modifying a color signal.

FIG. 10 shows a combination of circuit(s) and/or software program(s).

FIGS. 11A and 11B show a color stripe detector or phase detector.

FIGS. 12A and 12B show prior art network or distribution systems.

FIGS. 13A to 13D show embodiments with mapping and/or detection methods.

FIGS. 14A and 14B show transforming from one TV standard to another including content control or copy protection signal(s).

FIGS. 15-19 show mapping relations or functions in matrix form for various TV formats and content control signal(s).

FIG. 20 shows in a table an example of various signal modifications for different TV standards.

FIG. 21 shows examples of content control signal mapping in matrix form from a same or different TV standard.

FIG. 22 shows a reader or detector in a block diagram.

FIG. 23 shows a scaler (converter) in a block diagram.

### DETAILED DESCRIPTION

In accordance with the present invention, control or configuration bit(s) in a TV signal may be used to set or provide one or more modifications to a HD, SD (standard definition), or Low Definition (e.g., low definition may be less than 525 lines) video signal. For example, the content control system defined in the following tables is used in exemplary embodiments.

TABLE 1
Mode Control Bit Listing
Routine On/Off and Mode Selection

| N0 | On/off and mode control; 8 bits | | |
|---|---|---|---|
| N0[7] | Reserved | | CPC0[3] |
| N0[6] | Pay-to-tape allowed/prohibited | (Allowed = 1, | CPC0[2] |
| | | Default = 0) | |
| N0[5] | VBI pulses On/Off (VBIP) | (ON = 1) | CPC0[1] |
| N0[4] | End of Field Back Porch Pulses | (ON = 1) | CPC0[0] |
| | on/off (EOFP) | | |
| N0[3] | Colorstripe process On/Off (CSP) | (ON = 1) | CPC1[3] |
| N0[2] | AGC pulse normal (amplitude | (Cycling = | CPC1[2] |
| | cycling)/static mode select (AGCY) | Default = 1) | |
| N0[1] | H-sync amplitude reduction On/Off | (ON = 1) | CPC1[1] |
| | (HAMP) | | |
| N0[0] | sync amplitude reduction On/Off | (ON = 1) | CPC1[0] |
| | (VAMP) | | |

Table 1 shows a copy control specification using a set of 8 digital data bits designated NO[0] to NO[7] to be inserted into or provided with a video signal as described herein to define various control management states. The first column shows the bit number (zero to 7, where 7 is not used). The second column shows the control management state in terms of e.g. pay-to-tape (bit 6) or various well known analog domain copy prevention schemes, operating in the analog video domain, as defined by Macrovision Corp., see U.S. Pat. No. 6,381,747 incorporated herein by reference in its entirety. The third column shows the significance of each bit being “ON” (value 1) or OFF (value zero). The fourth column refers to CPC, copy protection control or commands CPC[0] to CPC[3].

TABLE 1a
Summary of 525/60/NTSC Measurements

| | Measurement |
|---|---|
| Parameter | (±S) |
| Burst Normal Start Point (Colorstripe Line) | 5.3 ± 0.15 |
| Burst Advanced Start Point (Colorstripe Line) | 4.96 ± 0.15 |
| | (Note 1) |
| Envelope Rise Time 10%-90% | 0.3 + 0.1/−0.2 |
| Burst Start to First Phase Switch Point | 1.48 ± 0.07 |
| First to second phase switch points | 0 |
| Second Phase Switch Point to end of burst | 1.48 ± 0.15 |
| | (Note 1) |
| Envelope Fall Time 10%-90% | 0.3 + 0.1/−0.2 |

(Note 1) Start and End points must be such that total burst duration for the default configuration is 2.96 + 0.15/−0.07

Table 1a shows in the prior art for the NTSC TV standard (525 lines/field, 60 frames/second) timing information in terms of an NTSC video waveform for the Macrovision Corp. well known color stripe process which is bit 3 in Table 1. (“Burst” in Table 1 a refers to the video color burst.)

TABLE 1b
LINE NUMBERS INCORPORATING
ADVANCED SPLIT BURST WAVEFORM (NTSC)

| | |
|---|---|
| Advanced Split Burst | Advanced split Burst |
| 4-Line version | 2-Line version |
| (21-Line Spacing) | (17-Line Spacing) |
| First line in stripe | First line in stripe |

| Stripe No. | Field 1 | Field 2 | Field 1 | Field 2 |
|---|---|---|---|---|
| 1 | 24 | 297 | 30 | 301 |
| 2 | 45 | 318 | 47 | 318 |
| 3 | 66 | 339 | 64 | 335 |
| 4 | 87 | 360 | 81 | 352 |
| 5 | 108 | 381 | 98 | 369 |
| 6 | 129 | 402 | 115 | 386 |
| 7 | 150 | 423 | 132 | 403 |
| 8 | 171 | 444 | 149 | 420 |
| 9 | 192 | 465 | 166 | 437 |
| 10 | 213 | 486 | 183 | 454 |
| 11 | 234 | 507 | 200 | 471 |
| 12 | | | 217 | 488 |
| 13 | | | 234 | 505 |

Table 1b similarly provides detail in the prior art of the color stripe process of Table 1. This process is conventionally used in a 2 (video) line and 4 (video) line format. “Split burst” refers to the feature in the color stripe process where only a part of the color burst is altered. The color burst process, as defined in Table 1b, is only present on the selected video lines as shown.

TABLE 2a
Summary of 625/50/PAL Measurements

| | Measurement |
|---|---|
| Parameter | (±S) |
| Burst Normal Start Point (Colorstripe Line) | 5.6 ± 0.15 |
| | (Note 1) |
| Burst Advanced Start Point (Colorstripe Line) | 4.96 ± 0.15 |
| Envelope Rise Time 10%-90% | 0.3 + 0.1/−0.2 |
| Burst Start to First Phase Switch Point | 1.185 ± 0.07 |
| First to second phase switch points | 0 |
| Second Phase Switch Point to end of burst | 1.185 ± 0.15 |
| | (Note 1) |
| Envelope Fall Time 10%-90% | 0.3 + 0.1/−0.2 |

(Note 1) Start and End points must be such that total burst duration for the default configuration is 2.25 + 0.15/−0.07

TABLE 2b
LINE NUMBERS INCORPORATING
COLORSTRIPE BURST WAVEFORM (PAL)

Colorstripe Burst
2 or 3-Line version
(34-Line Spacing)
First line in stripe

| Stripe No. | Even Field | Odd Field |
|---|---|---|
| 1 | 27 | 356 |
| 2 | 61 | 390 |
| 3 | 95 | 424 |
| 4 | 129 | 458 |
| 5 | 163 | 492 |
| 6 | 197 | 526 |
| 7 | 231 | 560 |
| 8 | 265 | 594 |

Tables 2a and 2b are in the prior art similar respectively to Tables 1a and 1b, for PAL standard television (common outside the U.S.A.) having 625 lines per field and 50 frames per second.

TABLE 3

| | | | | | Luma | Luma | |
|---|---|---|---|---|---|---|---|
| | Samples | Active | | | Sampling | Sampling | |
| | per Active | Lines per | Frame | Scanning | Frequency | Period (T) | |
| System Type | Line | Frame | Rate (Hz) | Format | (MHz) | (nS) | A |
| 1920 × 1080/60/1:1 | 1920 | 1080 | 60 | Progressive | 148.500 | 6.734 | 44 T |
| 1920 × 1080/59.94/1:1 | 1920 | 1080 | 59.95 | Progressive | 148.352 | 6.741 | 44 T |
| 1920 × 1080/50/1:1 | 1920 | 1080 | 50 | Progressive | 148.500 | 6.734 | 484 T |
| 1920 × 1080/60/2:1 | 1920 | 1080 | 30 | 2:1 Interlace | 74.250 | 13.468 | 44 T |
| 1920 × 1080/59.94/2:1 | 1920 | 1080 | 29.97 | 2:1 Interlace | 74.176 | 13.481 | 44 T |
| 1920 × 1080/50/2:1 | 1920 | 1080 | 25 | 2:1 Interlace | 74.250 | 13.468 | 484 T |
| 1920 × 1080/30/1:1 | 1920 | 1080 | 30 | Progressive | 74.250 | 13.481 | 44 T |
| 1920 × 1080/29.97/1:1 | 1920 | 1080 | 29.97 | Progressive | 74.176 | 13.468 | 44 T |
| 1920 × 1080/25/1:1 | 1920 | 1080 | 25 | Progressive | 74.250 | 13.481 | 484 T |
| 1920 × 1080/24/1:1 | 1920 | 1080 | 24 | Progressive | 74.250 | 13.468 | 594 T |
| 1920 × 1080/23.98/1:1 | 1920 | 1080 | 23.98 | Progressive | 74.176 | 13.481 | 594 T |
| 1920 × 1080/30/1:1 SF | 1920 | 1080 | 30 | Prog. SF | 74.250 | 13.468 | 44 T |
| 1920 × 1080/29.97/1:1 SF | 1920 | 1080 | 29.97 | Prog. SF | 74.176 | 13.481 | 44 T |
| 1920 × 1080/25/1:1 SF | 1920 | 1080 | 25 | Prog. SF | 74.250 | 13.468 | 484 T |
| 1920 × 1080/24/1:1 SF | 1920 | 1080 | 24 | Prog. SF | 74.250 | 13.468 | 594 T |
| 1920 × 1080/23.98/1:1 SF | 1920 | 1080 | 23.98 | Prog. SF | 74.176 | 13.481 | 594 T |
| 1280 × 720/60/1:1 | 1280 | 720 | 60 | Progressive | 74.250 | 13.468 | 70 T |
| 1280 × 720/59.94/1:1 | 1280 | 720 | 59.94 | Progressive | 74.176 | 13.481 | 70 T |
| 1280 × 720/50/1:1 | 1280 | 720 | 50 | Progressive | 74.250 | 13.468 | 400 T |
| 1280 × 720/30/1:1 | 1280 | 720 | 30 | Progressive | 74.250 | 13.481 | 1720 T |
| 1280 × 720/29.97/1:1 | 1280 | 720 | 29.97 | Progressive | 74.176 | 13.468 | 1720 T |
| 1280 × 720/25/1:1 | 1280 | 720 | 25 | Progressive | 74.250 | 13.481 | 2380 T |
| 1280 × 720/24/1:1 | 1280 | 720 | 24 | Progressive | 74.250 | 13.468 | 2545 T |
| 1280 × 720/23.98/1:1 | 1280 | 720 | 23.98 | Progressive | 74.176 | 13.481 | 2545 T |

| | | | | | | | X | |
|---|---|---|---|---|---|---|---|---|
| | | | | | | | BPP | Total |
| | | | | | | | Pulse | Lines per |
| System Type | B | C | D | E | F | G | Width | Frame |
| 1920 × 1080/60/1:1 | 44 T | 44 T | 148 T | 280 T | 1920 T | 2200 T | 44 T | 1125 |
| 1920 × 1080/59.94/1:1 | 44 T | 44 T | 148 T | 280 T | 1920 T | 2200 T | 44 T | 1125 |
| 1920 × 1080/50/1:1 | 44 T | 44 T | 148 T | 720 T | 1920 T | 2640 T | 44 T | 1125 |
| 1920 × 1080/60/2:1 | 44 T | 44 T | 148 T | 280 T | 1920 T | 2200 T | 44 T | 1125 |
| 1920 × 1080/59.94/2:1 | 44 T | 44 T | 148 T | 280 T | 1920 T | 2200 T | 44 T | 1125 |
| 1920 × 1080/50/2:1 | 44 T | 44 T | 148 T | 720 T | 1920 T | 2640 T | 44 T | 1125 |
| 1920 × 1080/30/1:1 | 44 T | 44 T | 148 T | 280 T | 1920 T | 2200 T | 44 T | 1125 |
| 1920 × 1080/29.97/1:1 | 44 T | 44 T | 148 T | 280 T | 1920 T | 2200 T | 44 T | 1125 |
| 1920 × 1080/25/1:1 | 44 T | 44 T | 148 T | 720 T | 1920 T | 2640 T | 44 T | 1125 |
| 1920 × 1080/24/1:1 | 44 T | 44 T | 148 T | 830 T | 1920 T | 2750 T | 44 T | 1125 |
| 1920 × 1080/23.98/1:1 | 44 T | 44 T | 148 T | 830 T | 1920 T | 2750 T | 44 T | 1125 |
| 1920 × 1080/30/1:1 SF | 44 T | 44 T | 148 T | 280 T | 1920 T | 2200 T | 44 T | 1125 |
| 1920 × 1080/29.97/1:1 SF | 44 T | 44 T | 148 T | 280 T | 1920 T | 2200 T | 44 T | 1125 |
| 1920 × 1080/25/1:1 SF | 44 T | 44 T | 148 T | 720 T | 1920 T | 2640 T | 44 T | 1125 |
| 1920 × 1080/24/1:1 SF | 44 T | 44 T | 148 T | 830 T | 1920 T | 2750 T | 44 T | 1125 |
| 1920 × 1080/23.98/1:1 SF | 44 T | 44 T | 148 T | 830 T | 1920 T | 2750 T | 44 T | 1125 |
| 1280 × 720/60/1:1 | 40 T | 40 T | 220 T | 370 T | 1280 T | 1650 T | 40 T | 750 |
| 1280 × 720/59.94/1:1 | 40 T | 40 T | 220 T | 370 T | 1280 T | 1650 T | 40 T | 750 |
| 1280 × 720/50/1:1 | 40 T | 40 T | 220 T | 700 T | 1280 T | 1980 T | 40 T | 750 |
| 1280 × 720/30/1:1 | 40 T | 40 T | 220 T | 2020 T | 1280 T | 3300 T | 40 T | 750 |
| 1280 × 720/29.97/1:1 | 40 T | 40 T | 220 T | 2020 T | 1280 T | 3300 T | 40 T | 750 |
| 1280 × 720/25/1:1 | 40 T | 40 T | 220 T | 2680 T | 1280 T | 3960 T | 40 T | 750 |
| 1280 × 720/24/1:1 | 40 T | 40 T | 220 T | 2845 T | 1280 T | 4125 T | 40 T | 750 |
| 1280 × 720/23.98/1:1 | 40 T | 40 T | 220 T | 2845 T | 1280 T | 4125 T | 40 T | 750 |

Note:
BBP Pulse Width measured at 50% points of leading and trailing edges of the pulse.

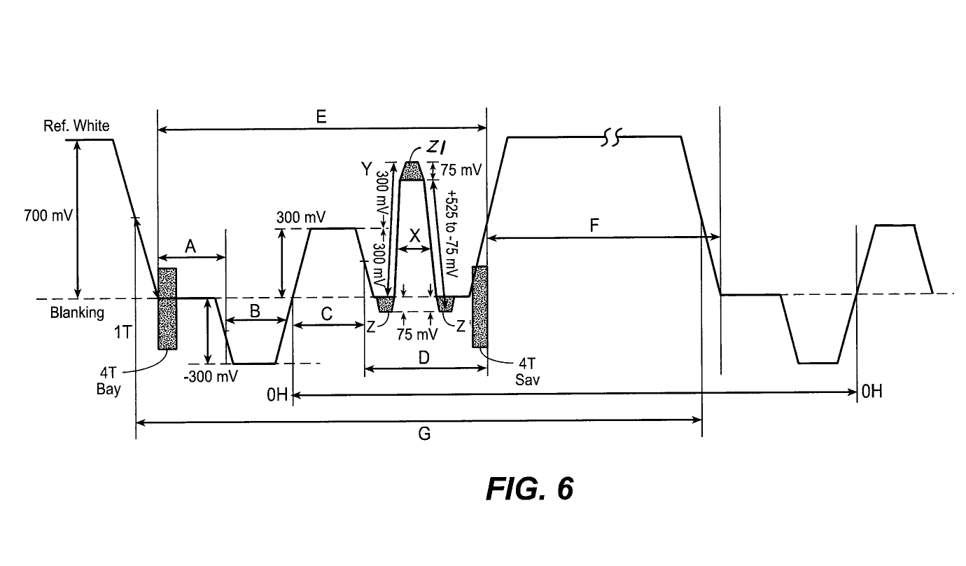

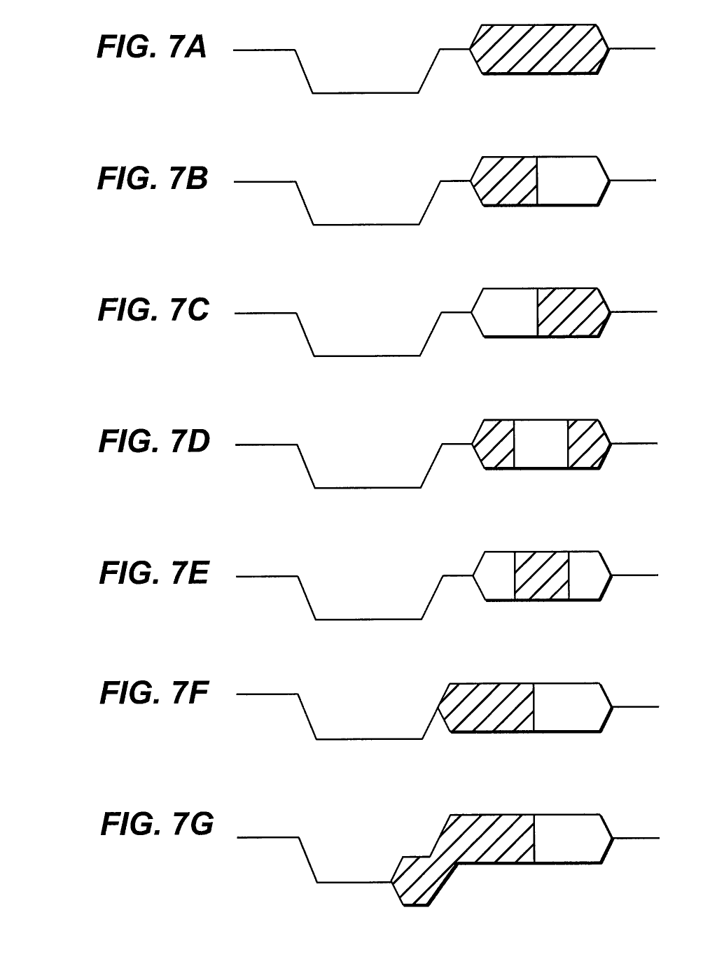

Table 3 shows in each line (row) a known HDTV format (standard), and in each column relevant parameters for that format. Columns A, B, C, D, E, F, G refer to the waveform parameters shown in FIG. 6, which shows a waveform for tri level sync pulse in a TV signal. A refers to a front porch duration, B refers to a negative going sync pulse duration, C refers to a positive going sync pulse duration, D refers to a back porch duration, E refers to a horizontal blanking interval duration, F refers to an active TV line duration, G refers to a line duration, and X refers to a positive going pulse duration in a portion of a back porch region (e.g., of one or more selected TV line(s)). So for example, “X” refers to a BPP (back porch pulse which is a known Macrovision Corp. copy protection signal) for a duration or pulse width of 40T or 44T wherein T is 1/[luma sampling frequency]. Table 3 is thus a detailed example of how the conventional copy protection BPP (back porch pulse) signal may be implemented in various HD formats. Thus, Table 3 with FIG. 6 shows a detailed example of how one type of content control signal (e.g., back porch pulse or positive going pulse in a horizontal blanking interval) may be implemented for various HDTV standards. Other types of content control signal modifications may be implemented in the various HDTV standards tabulated in Table 3. For example, a level shifting signal, a modulated waveform/signal, a periodic (or aperiodic) signal of finite duration, a negative going signal or pulse, a deletion/attenuation, position change, scaling, or blanking of at least a portion of any of the HDTV may be provided as a content control.

In one example, the presence of any of the (standard definition) signal modifications of Tables 1, 1a, 1b, or any variants (e.g., different line assignments, different number of pulses, color burst modification, different position, amplitude, or duration of pulses, etc.) may be used to map a set of content control signals to another TV standard (e.g., HDTV or modifications shown in Table 3). For example, one or more modifications in an incoming HDTV signal may be sensed or read so that a set of corresponding signal modification(s) may be applied downstream to a lower definition type TV signal such as standard and/or low definition TV.

A further example includes a signal wherein the TV standard 240p, 525I, or 625I signal includes a color burst or subcarrier modification (e.g., of incorrect phase or frequency) which is coupled to a compliant system that can provide a high definition TV signal. This compliant system upon sensing a color burst or subcarrier modification in signals which are non-HDTV standard can then provide a modified HDTV signal (e.g., an HDTV signal with provided in a blanking interval, a periodic or an aperiodic signal, a positive and/or a negative going pulse in one or more TV line(s)). In another example, a compliant system may receive a HDTV signal that includes a signal modification (e.g., such as a signal or pulse in a blanking interval), and this particular compliant system may provide a non-HDTV signal, which may include a color burst or subcarrier modification. Note in these examples, the color burst or subcarrier modification may be replaced with other copy protection signals such as pseudo sync pulses, AGC pulses, narrowed sync pulses, level shifted pulses (static and/or dynamic).

FIG. 1 shows in a block diagram a reader 10, which detects, reads, and/or interprets copy control modifications as described here to an HD (or SD) TV signal input at terminal 11. For example, reader 10 may sense or read in an input SD TV signal at least one back porch pulse, pseudo sync pulse, incorrect phase color signal, incorrect frequency color signal, incorrect color signal, incorrect luma signal, raised or lowered video portion (e.g., front and/or back porch area), and/or frequency of an added signal, while also have the capability of reading similar modifications to an HD signal. Reader 10 may be coupled to receive an analog and/or digital (TV) signal for detection or interpretation. Reader 10 may be imbedded in or part of an apparatus for converting analog HD/SD signals into one or more types of digital signal(s). Reader 10 may be utilized to control content control by sending a video signal out at terminal 12 that includes one or more commands to prohibit recording, transmission, and/or displaying in accordance with the copy control signal or data it reads from the input video. Reader 10 may include on the output video a signal to affect the digital output signal or include a “flag” signal.

The output signal from reader 10 may be coupled or integrated to an input terminal of a computer, recorder, player, network, encoder, video compressor, and/or video decompressor device. Reader 10's output signal at terminal 10 may include a command or control sent to a computer, recorder, etc. to limit recording, viewing, or modify the viewing/recording resolution. In essence, the output signal of reader 10 at terminal 12 is coupled to a control input terminal of the computer, recorder, player, network, encoder, video compressor, and/or video decompressor device. For example reader 10 may be utilized to limit recording, storage, transmission, decompression, and/or playing in a device based on interpreting the signal input at terminal 11, which may be in the form of low, standard, and/or high definition signals.

FIG. 2A shows in a similar block diagram an encoding device 20, which for example may encode a modification as described above with reference to FIG. 1 to video signal(s) input at terminal 21, conforming to one or more HD TV standards (and/or one or more SD (standard definition) or LD (low definition) standards). The modification signal can be triggered or commanded by one or more configuration or control bit(s) and/or reading modification and/or data from an input analog signal. For example, encoder 20 may encode any modification to an HD signal based on a command. This command for example may come from one or more configuration bits and/or modifications read via reader 10 from an LD, SD and/or HD analog (or digital) signal.

In one example, encoder 20 has the capability to provide modifications to HD, SD, and/or LD signal(s) output at its terminal 22. For instance, encoder 20 may include providing color burst or subcarrier modification(s), AGC pulses, pulses, sync width or amplitude modification, horizontal blanking duration modification, and/or level shifting in the LD and/or SD TV standard, while in HD providing a modification to a tri level sync signal, inserting/generating positive going pulse in one or more horizontal or vertical blanking intervals.

FIG. 2B shows a block diagram of a generator 30 having input terminal 31 and output terminal 32, which for example generates various signals such as positive and/or negative going signal(s), sync modifications, color signal modifications. Generator 30 may also be part of encoder 20. Encoder 20 may also include subcarrier and/or sync processing to provide one or more subcarrier frequencies for LD and/or SD TV standards, and/or sync position, duration, assignment, and amplitude parameter(s). Generator 30 or encoder 20 may include programmability that is capable of being updated by data, transmission, input, and/or storage method(s). This programmability allows over cross platforms or TV standards that new content control or copy protection signals may be provided. An updated signal modification may be initiated at a system operator or via transmission, data file, and/or control bit(s). The programmability feature may also be provided for the reader 10 (e.g., so that when new modification or content control signals are implemented, a reader may be updated accordingly to track or interpret or sense any of the new content control signals or signal modification). Reader 10 thus may be a programmable reader for cross platforms (e.g., for multiple TV standards, or for HDTV standards, or for HDTV standards and other lower resolution TV standard(s)).

FIG. 2C shows a scaler (transcoder) 40 having input terminal 41 and output terminal 42, which allows modification of an incoming video signal at 41 to a different TV standard signal at output terminal 42. The scaler can conventionally change the line, pixel, and/or field rate. Alternatively scaler 40 may keep the same line and/or field rate and change a color standard. Block 40 may change the aspect ratio and/or invoke a letterbox format.

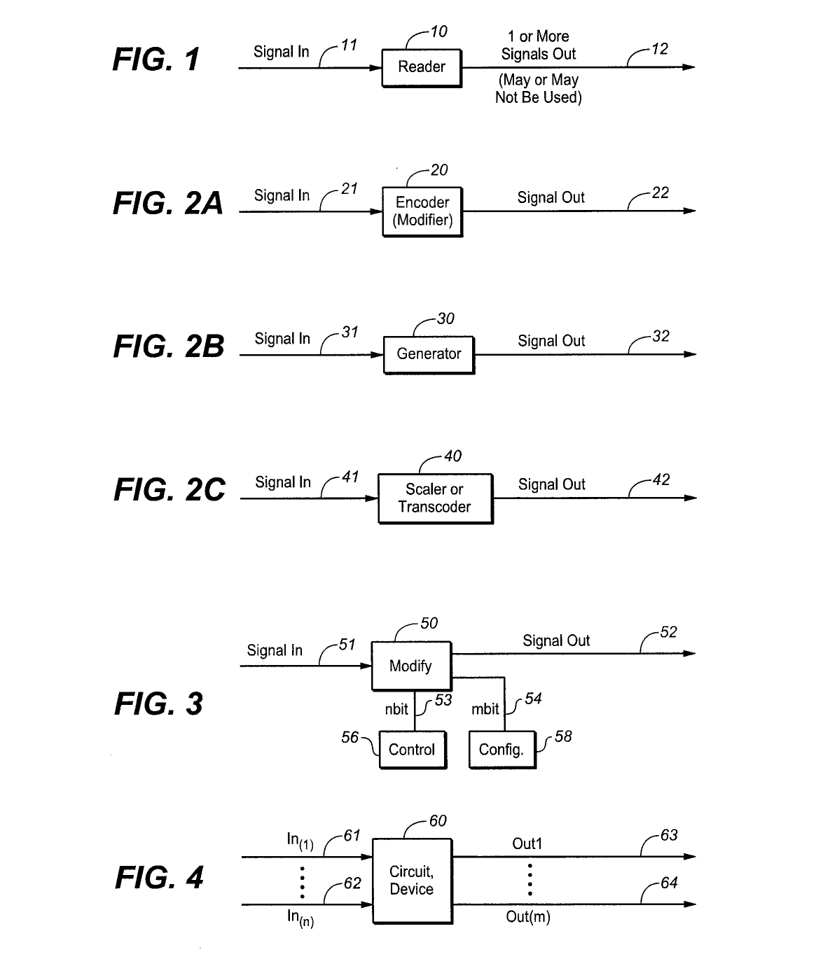

FIG. 3 shows an example of a video signal modifier apparatus 50 in a block diagram, which can be controlled by an n-bit control signal applied at terminal 53 from control logic 56 and/or by an n-bit control signal applied at terminal 54 from logic 58. The output signal of modifier 50 is at terminal 52.

FIG. 4 shows an example of a device or apparatus 60, which can receive one or more input signals IN(1), . . . , IN(n) on input terminals 61, . . . , 62 and output one or more output signals OUT(1) . . . , OUT(n) on terminals 63, . . . , 64. Device 60 may be a reader, decoder, and/or encoder. The input/output signals are, e.g., digital video data, an RF video signal, a baseband video signal, or a modulated video signal.

In one implementation, device 60 which is, e.g., an ATSC tuner, set top box, cell (mobile) telephone (e.g., a cell phone receiving DTV, HDTV, or ATSC signals), a WiFi or Wimax apparatus receives RF (radio frequency) signals. Upon receiving program video and a content control command in RF form, device 60 then outputs from its lookup table or performs a mapping function to provide content control signals for multiple or cross platform TV standards (e.g., HDTV content control (or copy protection or weakened copy protection) signal(s) plus SD or LD copy protection (content control) signal(s)). An example of an HDTV copy protection signal is a signal that causes an erroneous gain to be provided in an HD device (e.g., AGC error or clamp error), and/or a signal that causes unreliable timing or synchronization in an HD device (e.g., line or field/frame jitter or tearing effect). An HD content control signal may include a signal that is read or sensed by a compliant device to assert a command (e.g., shut down, change quality of video or audio, restrict program use, scramble, etc.).

In another example, device 60 receives a television signal conforming to a lower resolution standard, but outputs a higher resolution standard video signal, or vice versa. For example if the lower resolution signal is 240 scan lines per field and is provided into device 60, the output signal of device 60 may be a video signal having 480 or 720 or 1080 scan lines by performing scaling. One or more of the scaled output video signal(s) may then include a content control, copy protection, or weakened copy protection signal.

Note that a content control signal may include any part of a copy protection signal or any part of a “weakened” copy protection signal. A weakened copy protection signal is a signal that has little or no conventional copy protection effect e.g., a color burst or subcarrier modification (e.g., incorrect phase and/or frequency) that has little or no effect on a conventional VCR (video cassette recorder), meaning little or no chroma copy protection effect on a VCR, or a weakened version of AGC and/or pseudo sync pulses to invoke little or no AGC effect on a VCR. But, the weakened signal can still be detected by a detector circuit and used for content control.

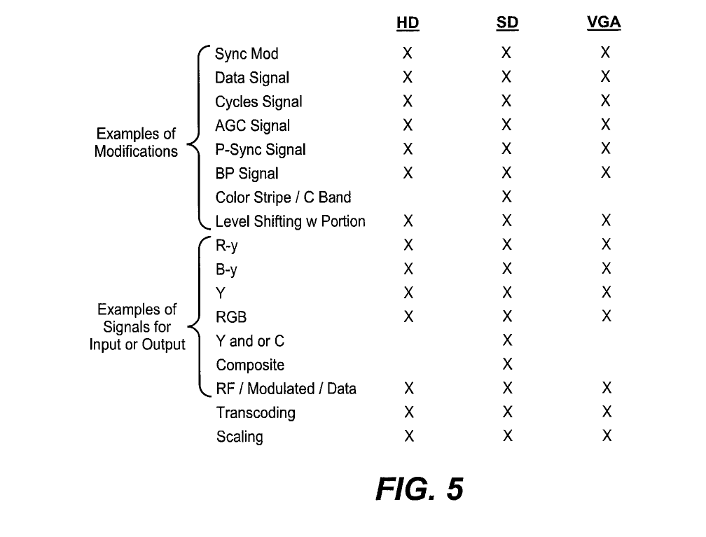

FIG. 5 shows (top part) in tabular form various copy protection signal modifications that may be applied to video signals conforming to various video standards (the columns of the table) which are HD, SD, and VGA. The bottom part of the table shows examples of types of well known input/output video signals conforming to HD, SD, and VGA.

FIG. 6 (referred to above) shows an example of a video waveform showing inserting/adding positive and/or negative going pulses in one or more HD or tri-level sync horizontal video signals. The added positive going pulse is denoted by “X” and is located in a portion of an overscan area (e.g., in a portion of a back porch region or in a horizontal or vertical blanking interval). In FIG. 6, pulse X is a positive going pulse or signal having variable or programmable duration, position, or amplitude. Also shown in FIG. 6 is a negatively going pulse or signal designated z, which may be generated or provided in an overscan portion of the video signal. Note that an overshoot or additional signal z1 may be added to pulse X. While in Table 3 and FIG. 6 nominal values of amplitude, position, and/or duration for pulses z, z1, and X are provided, other values may be provided or used.

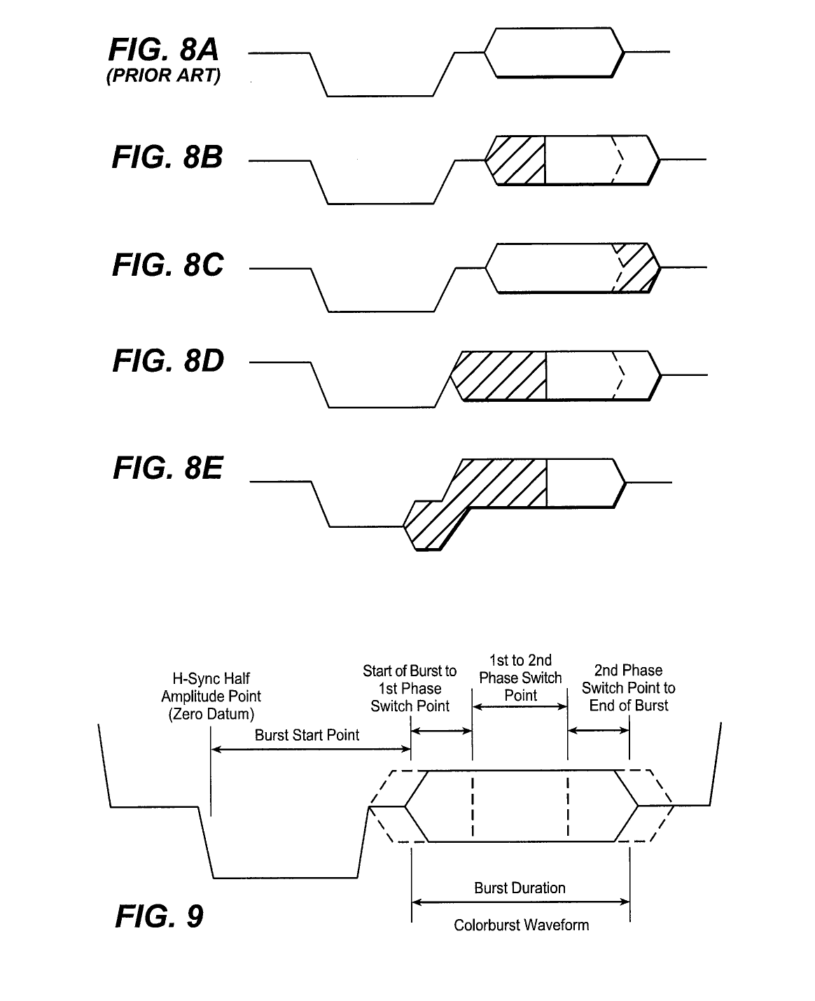

FIG. 8A shows a conventional video color burst waveform. FIGS. 7A-7G, 8B-8E and 9 show various exemplary known copy protection-type waveforms for modifying such a conventional video color burst signal, as generally known in the field and generally called the “color stripe” process by Macrovision Corp. These waveforms are generally modifications (shown in hatching) of the otherwise conventional color burst in a TV signal horizontal blanking interval of FIG. 8A. The hatched areas shown indicate phase, duration, amplitude, and/or frequency modification(s) to the color burst as explained in FIG. 9. Reader 10 of FIG. 1 detects an indication of phase, duration, amplitude, and/or frequency modification. For example, any of these waveforms may be sensed or detected in a video signal otherwise conforming to one or more SD TV standards so that in a corresponding video signal in an HDTV standard, the HDTV signal is modified (e.g., with a corresponding HDTV content control signal) or the HDTV signal transmitted, viewed, or recorded in a content controlled manner such as limited storage of the HDTV signal, limited access of the HDTV signal, or limited quality of the HDTV signal). Conversely, an HDTV signal when detected (e.g., in a compliant system) with or without a content control or copy protection signal (or flag) may be outputted in a lower resolution that includes any waveform (or variant) such as those illustrated in FIGS. 7A-7G, 9 or with the addition of another content control or copy protection signal(s) (e.g., pseudo sync pulses, AGC pulses, narrowed sync pulses, or weakened copy protection signal).

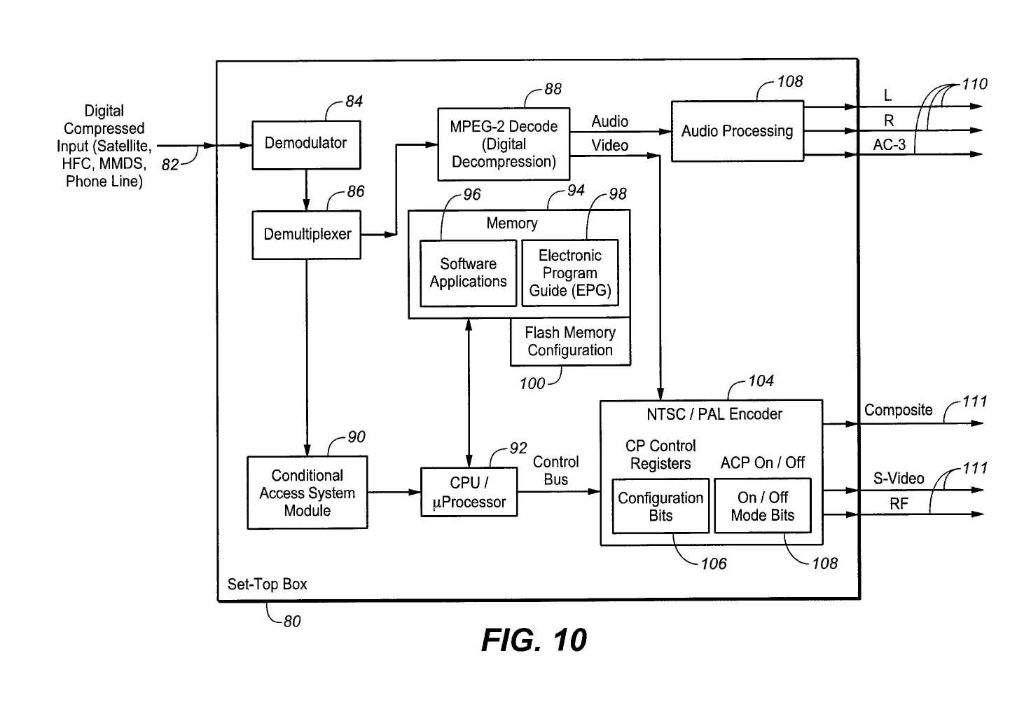

FIG. 10 shows an example in a block diagram of an apparatus for a mostly conventional TV set top box, device 80. This could also be part of a mobile telephone, PDA, or other networked device. In one embodiment device 20 provides both SD and HD TV outputs. A low definition TV signal output from device 80 may be provided with the SD signal output or with the HD signal output. For each TV standard (e.g., including HD), configuration bits or hardware determines content control signal(s). The configuration bit(s) may be stored, transmitted, programmed, or entered to apply content control signal(s) over multiple platforms or TV standards. For example, the SD type output signal may include one or more AGC pulses, pseudo sync pulses, narrowed or widened sync pulses, a modified subcarrier signal in one or more HBI or VBI, BPP, level shifted portion(s), or data signals.

Device 80 includes conventionally input terminal 82 for receiving digital compressed input TV or video, demodulator 84, demultiplexer 86, decoder 88, conditional access system module 90, processor (CPU) 92, memory 94, storing software applications 96 and electronic program guide 98, flash memory for configuration 100, audio processing circuitry 108, and audio output terminals 110. Also provided is the mostly conventional NTSC/PAL TV encoder 104 also having in accordance with the invention configuration bids 106 for determining copy protection, control registers and on/off mode bits 108 for determining copy protection (“ACP”) 102, and having video output terminals 111 for 3 types of video as indicated.

For example, the HD signal provided from device 80 may include BPP, data signal, negative and/or positive going signals or pulses, and/or modifications to luma and/or chroma channels. For instance, if a color burst (or subcarrier) modification is applied to a composite or S Video signal, a modification of Pb and/or Pr (color e.g., RGB) or color difference channel(s) for component video output(s) may be provided e.g., in HD or progressive TV standard e.g., 480p or 576 or 720p or 1080p, or an interlaced component TV standard. One example of a modification for a Pb and/or Pr channel modifies a level or provides a waveform in a portion of the HBI, VBI, or overscan area in one or more color or color different channel(s). Alternatively if a color burst or subcarrier modification is sensed in composite or S Video, content control signal(s) may be provided in the Y or luma channel of an HD TV signal.

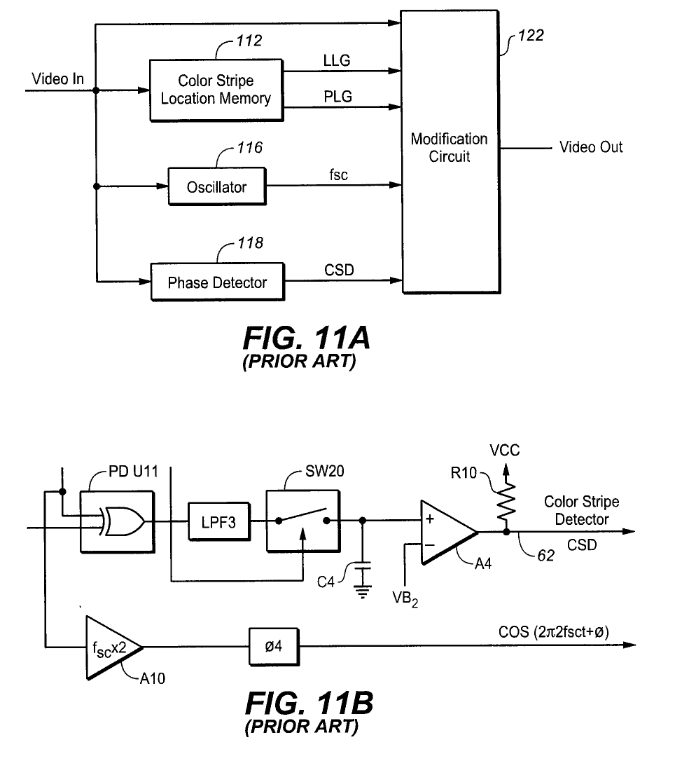

FIG. 11A shows in a block diagram an apparatus of known type to implement the present video signal modifications by detecting the color burst modification of FIGS. 7 and 8. The FIG. 11A apparatus includes conventionally for detecting Macrovision Corp. color burst copy protection signals (shown in FIGS. 7 and 8) a color stripe (line) location memory 112, oscillator 116, and the phase detector 118. Modification circuit 122, upon receiving the expected input signals, outputs on its “Video Out” terminal a modified video signal.

Phase detector 118 is replaced in other embodiments by a copy protection modification detector which detects an AGC pulse, pseudo sync pulse, incorrect color frequency in an overscan area, scaling effect(s), etc. Such a modification detector senses for example a color stripe signal or incorrect color frequency signal, and provides a signal indicative of the presence of the incorrect color subcarrier or burst signal. The indicative signal drives another circuit which inserts or generates a copy protection signal, weakened copy protection signal, control bit, or content control signal to a high definition video signal. FIG. 11B shows circuit detail of a conventional phase detector 118.

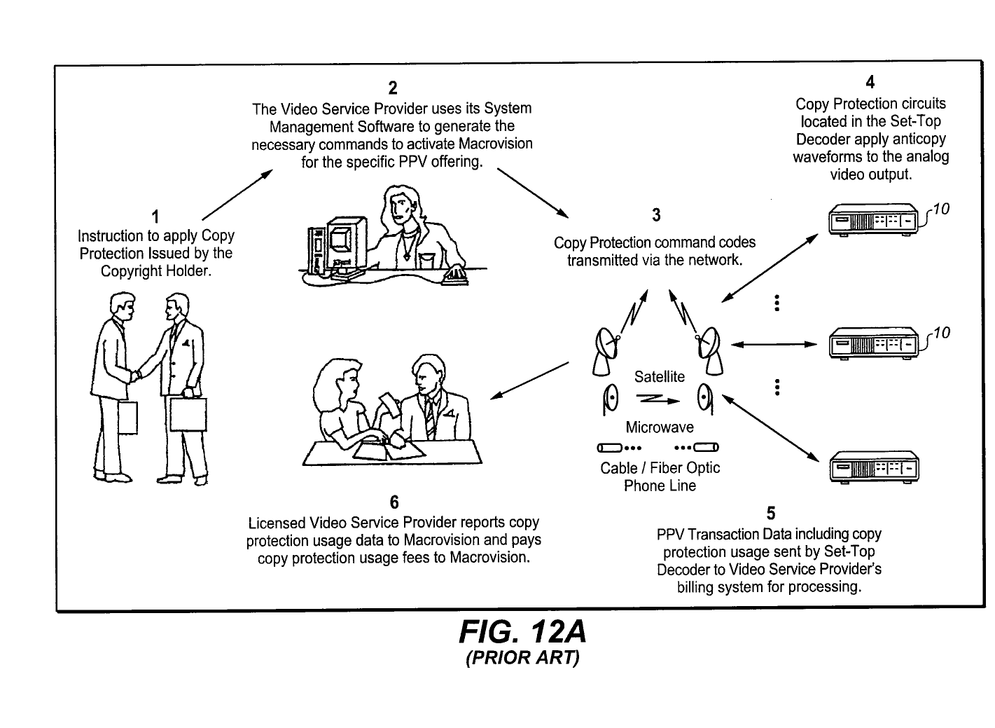

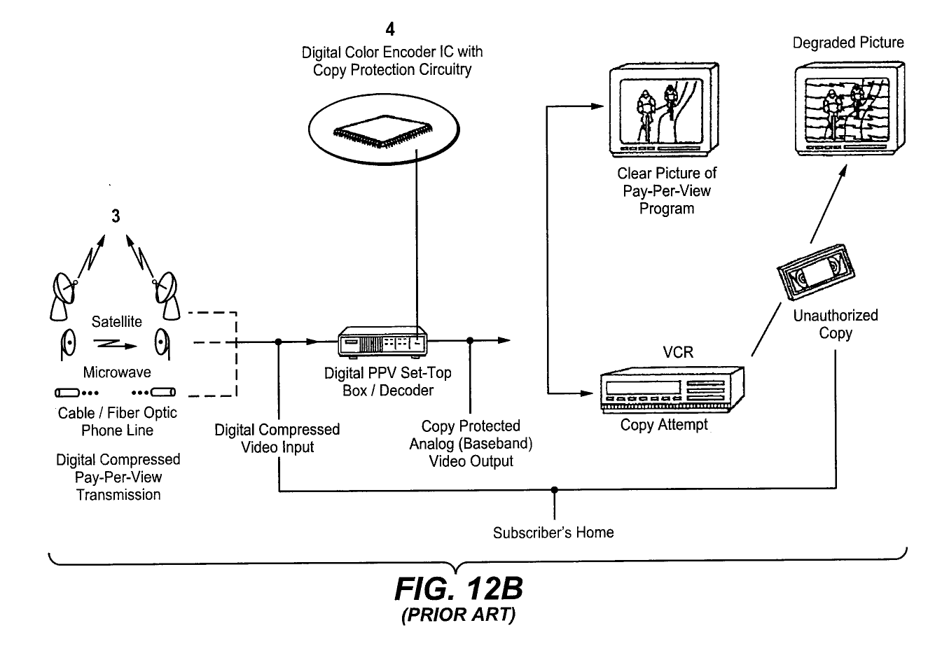

FIGS. 12A and 12B show pictorial examples of a prior art digital network environment, which can include set top boxes, cell phones, PDA'S, etc. Here the digital network is capable of providing standard and high definition signals, with each TV standard with a programmed content control signal. Such a digital network is capable of sending commands such as mode, APS, ECM/EMM, and/or configuration bits to enable or disable or to apply different forms of content control signals or varying degrees or defeated content control signals for high definition TV, or high definition TV plus another TV standard. Currently, no analog HD content control signals are commercially implemented. One embodiment of the present invention used in the environment of FIGS. 12A, 12B includes HD analog content control signals with content control signals of a different TV standard such as SD and LD. This is, one example is a chip or device that implements one set of content control signals for HD and another set of copy protection signals for SD and/or LD TV standards. Currently no commercially available devices implement the content control signals disclosed in US 2006/0093140. Such devices would include compatibility with HD and another TV standard with content control signals, with generally a different set of content control signals for each TV standards in accordance with the invention.

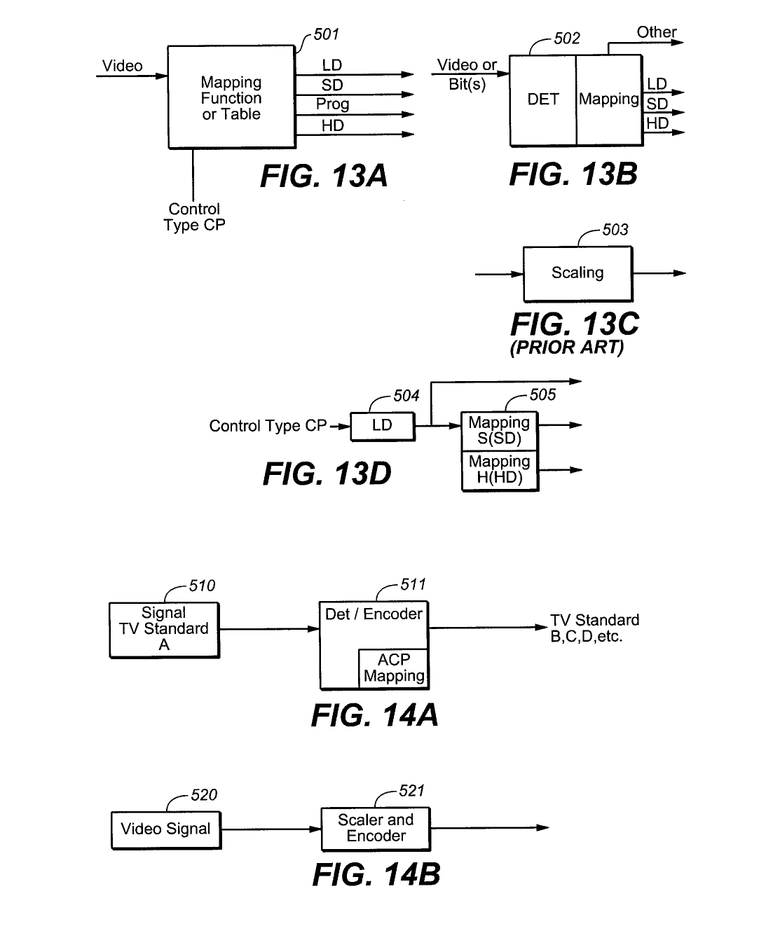

In FIGS. 13A, 13B and 13D, devices 501, 502, and 504 are each examples of a device (apparatus) in accordance with the invention that provides and/or detects multiple TV standard content control signals including at least an HD analog content control signal. An input video signal (digital or analog) is coupled into apparatus 501, which by means of an input control type signal CP copy protection and/or content control signals are provided for various TV standards. Device 501 thereby enables analog HD copy protection or content control with other TV standards. Device 501 includes, in one implementation, compatibility with different types of copy protection or content control signals for different types of TV resolutions. However, device 501 in general can independently provide control of programmable or presettable content control or copy protection signals for each set of TV resolutions. For example, one set of resolutions may include any combination of LD, SD, and/or HD. One example is to have standard definition and high definition, but other combinations are possible.

The mapping function or programmability of the various copy protection and/or content control signals in device 501 may be updated via transmission, input, or storage methods. The control type signal CP may include one or more mode, APS, and/or configuration bit(s). Signal CP may also be a function of reading data from the video source such as CGMS or the like. In the prior art for standard definition television the copy protection waveform may be updated via a digital file, a transmitted file, or by inputting data into a set top device or compliant device. This feature is implemented here in device 501 to change the HD analog content control signal in a similar fashion.

In FIG. 13B, device 502 shows inclusion with the mapping function of device 501 of a detector DET, which detects analog and/or digital signal(s). Device 502 thereby detects, for example, TV signals of one particular TV standard and corresponding associated copy protection signals, wherein the output of device 502 provides analog content control signals for HD TV. Alternatively, device 502 may receive an HD TV signal with analog content control signals and device 502 may output copy protection signals or content control signals conforming to SD or LD TV standards. For example, reading a certain number of back porch pulses from the HD signals may cause device 502 to output any combination of AGC, pseudo sync, color stripe, narrowed sync, lowered portion of video, etc. for scaled down SD and/or LD signals. In another illustration, device 502 may receive an SD or LD TV signal with any combination of AGC, pseudo sync, color stripe, narrowed sync, lowered portion of video, etc. and then device 502 may output an HD signals with a particular location and/or number of back porch pulses in the analog HD signal.

Device 502 allows receiving an HD signal of one type of content control signal and outputting an HD of another content control signal. In one example, device 502 detects a particular copy protection or content control signal for one TV standard, but outputs TV signals of one or more different TV standards. Any of these different TV standards, for example, may have independently or dependently presettable or programmable content control or copy protection signals. Device 502 may also output video having the same type of resolution as the input video or a scaled version of the input. In one example, a standard definition video signal is input to device 502 and the output of device 502 is a high definition video signal with a set of content control waveform(s) or signal(s). For example, if the input signal to device 502 is NTSC format with pseudo sync/AGC pulses, AGC pulses, narrowed sync, and/or color stripe burst signal, the output of device 502 may be in high definition component video (RGB or Y,Pb,Pr or the like), with back porch pulses or HBI (horizontal blanking interval) signals.

An example of apparatus 502 is a circuit or apparatus that includes a detector to detect one or more of the following for added signals in a portion of an HD or tri-level sync video signal A) a positive or negative going pulse(s) in an overscan area, B) a waveform provided in a portion of the HD or tri-level sync video signal, C) AGC (or pseudo sync or sync) pulse position and/or pulsewidth, D) AGC (pseudo sync or sync) pulse amplitude, E) detecting pseudo sync pulses that may be tri-level or two level, F) counting and/or identifying line/field/frame location for AGC pulse, pseudo sync pulse, or added waveform), G) a back porch or AGC signal detector, H) back porch or AGC pulse/signal counter; and or one or more of the following for a non HD or non tri-level sync video signal: 1) a color burst modification detector (such as a color stripe detector, 2) a color burst amplitude (amplitude variation) detector, 3) a frequency detector (e.g., apparatus or circuit to detect an incorrect color (or audio) subcarrier frequency or an incorrect (color and/or audio) subcarrier frequency for an associated TV standard), 4) pseudo sync pulse detector, 5) AGC pulse detector, 6) added/generated waveform (e.g., in a range of 10 KHz to 10 MHz in a portion of an overscan area) detector, 7) level shifted (positive and/or negative) portion of a front and/or back porch detector, 8) sync/pseudo sync duration detector, sync/pseudo position detector, sync/pseudo amplitude detector, an added/generated signal detector (positive and/or negative going pulse/signal/waveform provided in an overscan area or portion of a blanking interval) for one or more component video channel, a detector for a deleted portion of the video signal.

Apparatus 502 may be an encoding (or part of a coder-decoder-codec) apparatus or circuit, which receives a digital and/or analog signal and provides an HD standard with a form of ACP (e.g., a modification to an HD signal or no ACP signal or no effective ACP signal) along with providing a video signal that is not HD, such as SD or LD or composite (PAL, SECAM, or NTSC). Note that 502 may provide a form of composite HD or multiplexed component signal. Part of apparatus 502 is the detector DET, which detects for content control or copy protection or ACP signals or bits for HD and another TV standard.

In another example, a high definition component video signal with back porch, HBI (horizontal blanking interval), AGC or pseudo sync signals is input to apparatus 502, and the device outputs a composite video signal with color stripe signal(s), pseudo sync, sync narrowing, and/or back porch signals. The colors stripe signal here is generically defined as one or more cycles of color burst inserted or added in one or more HBI and being of incorrect phase or frequency. The color stripe signal here may or may not have an actual copy protection effect.

Conventional apparatus 503 of FIG. 13C performs a conventional scaling function as well known in the field, which transcodes (converts) from one TV standard to another, for example, from SD to HD format or vice versa. SD formats may include PAL, SECAM, NTSC, 480p, and/or 576p. HD may include interlaced or progressive formats. Such scaling is conventionally performed in set top boxes and digital media players.

In another embodiment as shown in FIG. 13D a conventional low definition video source 504 (including a control type signal) that is scaled to standard and/or high definition supplies video signals to apparatus 505. Apparatus 505 specifically is meant to operate with a low definition TV signal source 504, such as 240p format or the types of video signals provided from various portable devices such as cell phones, portable game players, iPods, etc. An example of apparatus 505 receives a low definition video signal (even having a reduced frame rate such as 20 or 15 frames a second from source 504) and up converts it to a HD or HD and SD TV signal with one or more sets of content control signals. The low definition signal may have one set of content control or copy protection signal(s), and the via a mapping (e.g., mapping function “S”) function for SD or mapping (e.g., mapping function “H”) function for HD, the video output of apparatus 505 may have pre-programmed content control and/or copy protection signals for SD and HD.

FIG. 14A shows a general example of a signal conforming to TV standard A from signal source 510 being coupled to an apparatus 511 with a detector/encoder (for detecting a copy protection or content control signal and also transcoding) and an ACP mapping function (e.g., look up table) to output a signal conforming to TV standards B, C, D, etc. with mapped content control and/or copy protection signals (which may be of SD or HD included). Source 510 is e.g. a DVD player, tuner, set top box, internet, etc. conforming to a particular TV standard. Typically the output signal may be HD so that apparatus 511 can scale the HD signal into another TV standard with an associated set of copy protection signals (e.g., LD with pseudo sync signals, or color stripe or AGC signal. Alternatively, source 510 may output a signal that is other than HD such as PAL, NTSC, or SECAM that is provided via the DVD player, tuner, set top box, Internet, apparatus 511 scales to an HD standard (1080p, 1080i, or 720p, or other HD format, or VGA/Super VGA standards), with a set of content control signals via the ACP mapping functions. FIG. 14A thereby shows how a TV signal of one standard such as NTSC from source 510 is coupled to an apparatus 511 in accordance with the invention. In apparatus 511 the detector senses any copy protection or content control signals from source 510. These content control signals include APS, configuration, or mode bits, or a subset of ACP signals such as pseudo sync, narrowed sync, AGC pulses, color burst modification, etc. Upon detection within apparatus 511 of one or more element from the content control signals and/or ACP signals of source 510, an ACP mapping function such as described below where “f” of {ACP signals of apparatus 510} maps into a set of “g” {ACP signals}n−1, wherein “g” represents generally a new set of content control and/or ACP signals for each different TV standard (of source 510). In this example, since source 510 is taken as conforming to the NTSC format, the mapping function “g” may output HDTV signal(s) at 720p, 1080i, and/or 1080p with an associated set of content control or copy protection signals for (each of) the HDTV standards.

In FIG. 14B video signal source 520 is a conventional program source, and device 521 is an embodiment to illustrate a video signal from source 520 linked or coupled to a scaling apparatus and encoder 521 to provide a new TV standard with content control and/or copy protection signal(s). Apparatus 521 includes the ACP mapping function of device 511 when the transformation of a different TV standard is made with a different set of ACP or content control signals.

A general way to express functionality of embodiments of the invention as described above is logically f(TVstandard₀, {ACP signals})→g(TVstandard₁₋ₙ, {ACP signals₁₋ₙ}). Here for example, a TV Standard “0” with a set of ACP Signals “0” is transformed or mapped to TV Standard(s) “1−n” with one or more sets of “ACP” Signals “1−n”. ACP (anticopy process) refers to a copy protection signal, weakened copy protection signal, video signal modification, and/or a content control signal. Here n=the number of TV standards. For example, Table 3 above shows 24 TV standards, so n=24 or TV standards that are labeled from 0 to 23, yields 24 TV standards. “f” generally refers to a first TV standard along with an associated ACP or content control signal, which is mapped to “g”, a set of at least one different TV standard and associated ACP or content control signals. In device 521, a set of ACP signals may be a different ACP signal, a weakened ACP signal, or a defeated/removed version of an ACP signal. So apparatus 521 represents both an encoder for processing various sets of ACP signals including HD, or a “black box” (e.g., circumvention device). For example, apparatus 521 may receive NTSC copy protected video with pseudo sync and/or color stripe ACP, and produces an HD signal or PAL signal without content control or copy protection signals.

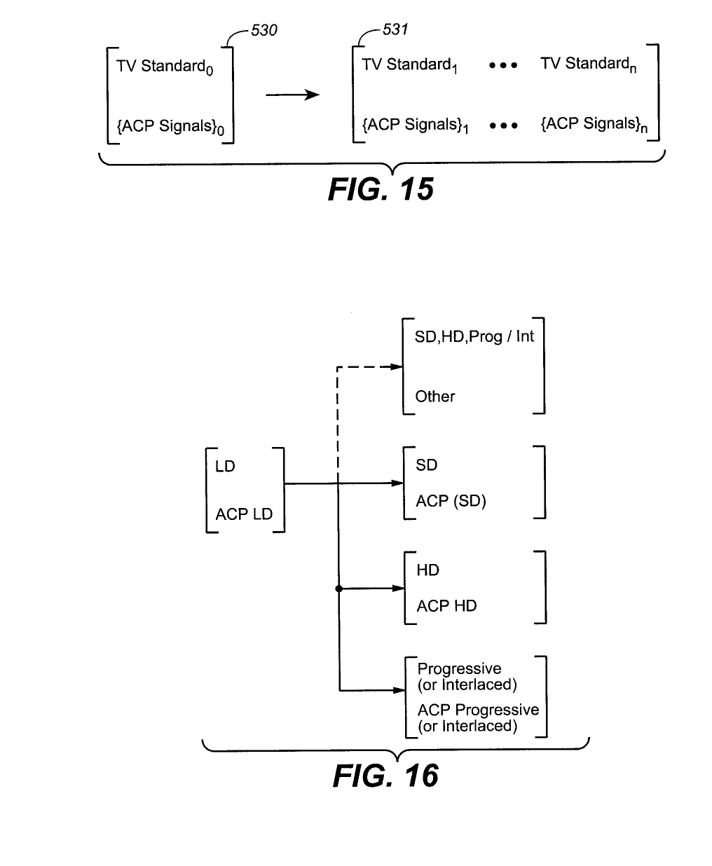

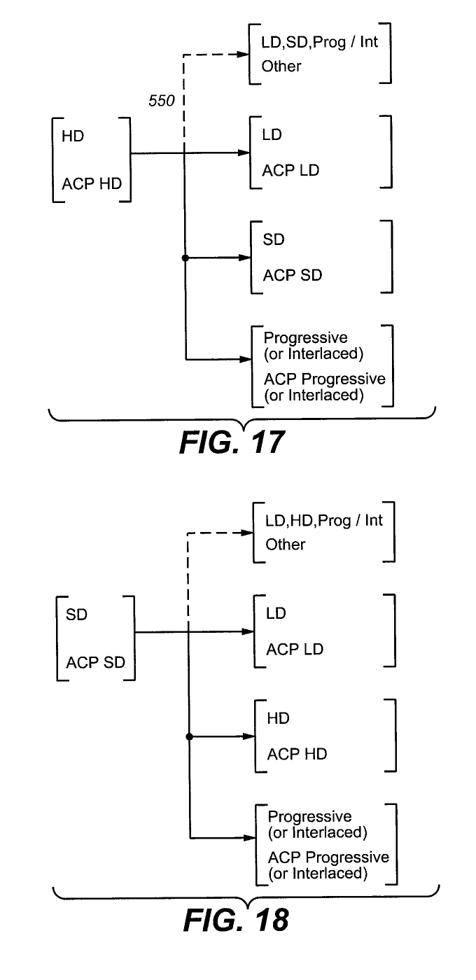

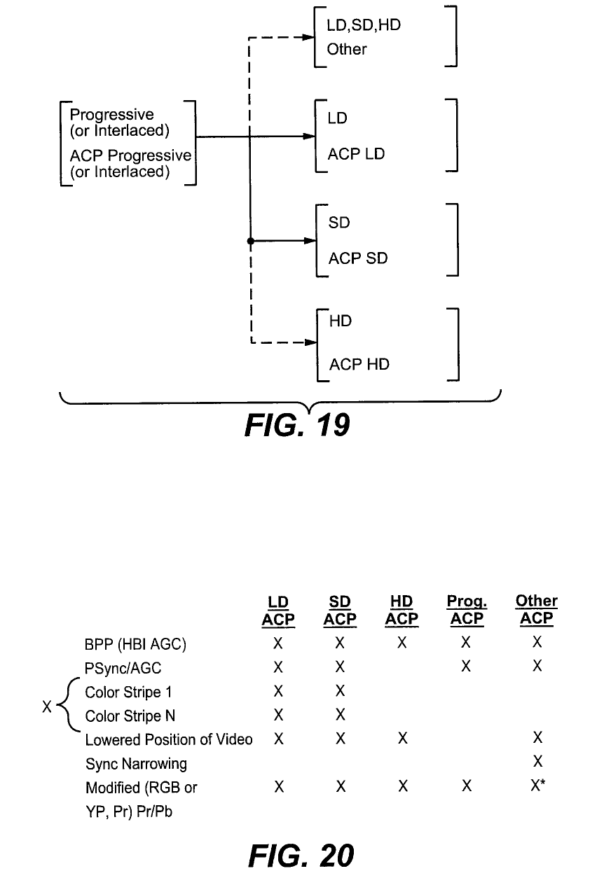

FIGS. 15-19 show in matrix diagrams specific TV standards for “f” and “g” referred to above. These diagrams show mathematical vectors that are mapped to a new set of vectors. That is FIGS. 15-19 show mathematically how the signals are represented as signal vectors and how the signal vectors are transformed as in FIGS. 14A and 14B. The ACP signal for each of FIGS. 15 through 19 may include: one or more content control signal, one or more copy protection signal, one or more copy protection enhancement signal (e.g., sync modification, level shifting a portion of the video signal, serrated sync pulse(s)), color burst modification (e.g., of incorrect phase, duration, amplitude, and/or frequency), weakened content control signal, weakened copy protection signal, data signal, modified data signal, added/generated waveform in a portion of the video signal, defeated (or no) content control signal, defeated (or no) copy protection signal, and/or defeated (or no) copy protection enhancement signal. For example, if the original signal is NTSC, which contains AGC/PS signals, then a VGA signal may contain AGC/pseudo sync signals to selected lines in the Green channel of the VGA video signal. For AGC/pseudo sync signals from PAL or NTSC, the output HDTV signal will have an AGC pulse in selected horizontal blanking intervals, but not necessarily any pseudo sync pulses.

It is routine engineering, in light of this disclosure, to design and make a chip or device that receives video content control or copy protections signals of one TV standard and then converts the video to another TV standard with removed content control or copy protection signals as described above. That is the chip or device may ignore APS bits, or analog copy protection or content control signals, and convert to a new TV format for anyone's use. In the case of a defeated ACP signal (meaning the ACP signal is weakened or removed) for example, a system of one TV standard may have at least some type of copy protection or content control system may be tranformed to another TV standard, which defeats/modifies/removes/attenuates the copy protection signal or the content control. For example, a TV signal with copy protection coming in for HDTV may be transformed to a SDTV signal with an ineffective ACP copy protection signal, or no ACP signal. “Ineffective” here is similar to weakened but includes having no effect. In one embodiment, FIGS. 14A and 14B-19 represent operation of a circumvention device e.g., when the resulting mapping which mathematically is the range provides an ineffective or removed ACP signal. For example, in apparatus 521, if the mapping relation or function “g” has ACP signal 1−n as ZERO or an ineffective ACP signal this will result in device 521 being an ACP circumvention device. For example, in “g” the ACP signals=0; or “g” means that no ACP or content control signal is provided to the transformed TV signal.

Conversely, a TV signal of one standard that has no ACP signal may be transformed into a signal conforming to another TV standard with an ACP signal. For example, an SDTV signal without ACP may be transformed to an HDTV signal with a form of ACP. In this example, in “f”, the ACP signals=0, but in “g”, the ACP signals=AGC pulses or (equivalent) color stripe signal or pulse pair pseudo sync/AGC signals or content control signal or video signal modification. There may be a need to add copy protection or content control signals whenever a TV standard is scaled or changed, regardless of the original input signal.

FIGS. 15 to 19 thereby show vector representations of the operation of apparatus 521 mapping into a matrix, wherein each column of each matrix represents a particular TV standard and/or set of content control and/or copy protection signal(s). The vectors may be part of the look up table implemented in logic or software in apparatus 521 (or 511) to implement in terms of added signals when TV standards are scaled. So the vectors express a specification on the chip level or the operations level of the chip or device. For example, suppose there is a particular multiple TV standard conforming DVR (digital video recorder) with inputs for NTSC. The vector description commands the device that when an NTSC signal is recorded with ACP signals such as color stripe signals, the output playback may be HDTV (e.g., 720p or 1080i) that contain back porch pulses (or an HDTV signal modification). In FIG. 15, matrix 530 represents the domain and matrix 531 represents a range. Hence matrix 530=the domain or the input signals before being transformed to a different TV standard, matrix 531=the range or the signals that have been transformed to another TV standard. The arrow represents a mapping relation or function, which may represent a change or transform in TV standard and/or ACP/content control signal. The arrow represents a transformation in TV standards, but also that a set of ACP signals may be changed or transformed as well. It depends on a transformation function, which is usually stored in memory, transmitted, or downloaded into apparatus 521 (or 511).

For example, FIG. 15 represents the functionality of scaler and encoder apparatus 521. A signal of one type of digital or analog TV signal with a set of copy protection/content control signal or bits is transformed to a new type of TV signal with a set of copy protection/content control signal(s)/bit(s) that can be changed or transformed or added/provided or deleted (or vice versa). In a further example, one of the TV standards in matrix 531 includes at least a tri-level sync or HD signal.

In yet another example, FIG. 15 represents in matrix form functionality of a decoding device (decoder). Here the source of video of one standard along with its associated content control/copy protection signal(s) is coupled or linked to an apparatus including the decoding device as in FIG. 14A. The detector may merely sense the presence of a particular ACP signal (or content control signal). A decoder would additionally interpret the signal. For example, the detector may detect pseudo sync pulses, but the decoder may also output the number of pseudo sync pulses detected or where the pseudo sync pulses were located in the VBI. A reader senses, counts or locates the pulses and then interprets what the pulses mean. So a reader may include an element to, for example, indicate three pseudo sync pulses found in line 10 of an NTSC VBI means to convert to format 720p and shut down recording after 1 hour. The decoder detects the particular TV standard and/or its associated content control/copy protection signal(s) and generates or provide an indicative signal (e.g., which TV standard, which content control information or copy protection signal). This indicative signal may then be used to provide a different TV standard and a set of content control or copy protection signal or video signal modification or deleted signal(s). For instance, an HD signal with one set of ACP signals is provided via transmission or storage and is coupled to an apparatus including the decoding device. The decoding device may provide an output SD or LD signal with no ACP, ACP, content control signal(s), or SD or LD signal modification. In one instance the HD conforming signal may have an ACP signal as defined as any of: no copy protection signal, no content control signal, copy protection signal, or content control signal.

It is possible for the decoding device (decoder) to receive an unprotected signal of one TV standard and output another TV standard with content control, copy protection, or signal modification, using a programmed algorithm or look up table. This can be a default condition or assume that the unprotected video signal was originally a “hacked” version of a copy protected video signal. For example, the unprotected video signal supplied via a black box may still have parts of the original copy protection signals such as narrowed syncs or lowered back porch, or one or two back porch pulses. Upon sensing any remaining modifications or parts of the original copy protection signal, the decoding device will change the TV standard and apply a more complete (e.g., effective) set of content control signals. The decoding device then can also be used to receive a TV signal and provide a TV signal with an added, strengthened, enhanced, weakened, or defeated form of content control/copy protection signal(s). Suppose an incoming source input video interlaced signal only has BPP (back porch pulse) ACP signals, then a decoding device may add PS (pseudo sync) pulses for progressive TV standards such as 480p or 720p as to prevent displaying on a monitor the input ACP signal. Recall that content control may involve inhibiting displaying (as oppose to inhibiting recording), so one can then say that the BPP signals included in the progressive TV format would stop recording, and the PS pulses added will stop displaying, and therefore the content control is strengthened, but this video signal can be still transmitted for example.

Another apparatus that embodies FIG. 15 is a transcoder that converts between TV standards. The transcoder may receive for example an HD signal with modifications (e.g., back porch pulses, pseudo sync, AGC pulses, waveform added, sync modifications, etc) and then output a digital or analog signal in another standard (e.g., SD or LD) with or without content control/copy protection signal(s), or vice versa (e.g., SD or LD in and HD out in the transcoder).

A transcoder apparatus may receive and output the same standard but provide a different signal modification in terms of type of content control or copy protection signal(s). For example a copy protection signal a first type A in coupled to the input of the device, which in turn outputs a copy protection signal of a second type. The copy protection signals of the two types may have no copy protection/content control signal in common, or have at least one signal or modification in common (e.g., both may include negative going pulses or positive going pulses, sync modifications, or added waveforms, etc.). Similarly as described here, conditions of the two types of copy protection may apply to a device receiving one TV standard and outputting a different TV standard. In terms of a transcoder, this device may include (or be coupled to) a recorder, storage device, computer, and/or transmitter.

FIG. 20 shows a look up table (mapping function) for the ACP signals for HD, SD, and LD standards similar to FIG. 5. Each column of FIG. 20 where the “x” is marked, indicates the elements of a set (of ACP or content control signals) for each TV standard, as described above with reference to “f” or “g” of FIG. 14B, apparatus 521. FIGS. 5 and 20 are only examples, and other features besides those listed such as BPP, etc. may be added, or a different list of features may be list for each TV standard. The elements are enabled for example by a memory circuit or control bit(s). The elements of the set may be changed or updated to provide a new list of ACP or content control signals for any of the TV standards, including HD. In this illustration typically a modified color burst signal is present on a signal conforming to a composite interlaced TV standard such as NTSC or PAL and/or to a low definition composite format (e.g., NTSC 240 progressive). In general, there is no such equivalent modified color burst signal in component video signals such as RGB or Y, Pr, Pb. However, as an option, one can modify in an HBI of the color difference Pr and/or Pb channel(s) or in the Y luminance channel to carry over an equivalence to a modified color burst. BPP, PS and others are just examples of content control or copy protection signals that may be used in any combination. Normally these signals are applied differently for different TV standards as seen in FIG. 20. For example, PS (pseudo sync) is included for SD but PS is not used in HD.

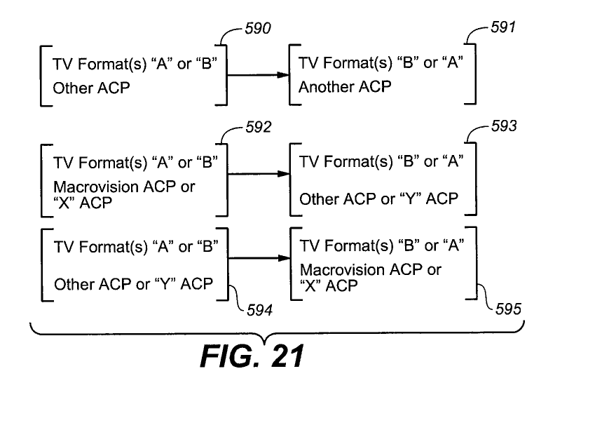

FIG. 21 is a diagram similar to FIG. 15 and shows that in some instances the two different TV formats are of essentially the same resolution. In FIG. 15 TV STANDARD_0 of matrix 530 may have the same resolution as TV STANDARD_1 of matrix 531. For example PAL-M has the same resolution as NTSC, or SECAM has the same resolution as PAL. So the detection of one content control or copy protection signal can have applied a different content control and/or copy protection signal. One example of the difference is to have a modification by adding and/or deleting one or more signals (or part of one or more signals) at matrix 591 of FIG. 21 from the original signal of matrix 590. The bottom left matrix is 594 and the bottom right matrix is 595 in FIG. 21. In some chips or devices, the ACP and/or content control signals may be proprietary, as in matrices 592 to 595. Hence there may be proprietary copy protection types X, Y, or Macrovision in matrices 592 to 595. So in the present method, a TV signal program video source may contain an ACP signal or content control signal of type Y, and the device receives this signal and outputs a TV signal of different standard but with type X's ACP or content control signal(s). So the receiving device such as device 502 in FIG. 13B may include a detector to detect or read content control or copy protection signals from multiple types. A device such as devices 510 or 502 or an IC (integrated circuit) of similar functionality would be capable of providing ACP or content control signals of two or more types (e.g., brands). In another example, suppose a digital video bit stream is provided to a set top box or media player (e.g., portable ATSC, DTV TV set and recorder) with Macrovision type APS or configuration bits, the set top box or media player may output a digital (or analog) signal with type X's content control bit(s) and/or output an (HD) analog video signal with type X's copy protection signal (or vice versa).

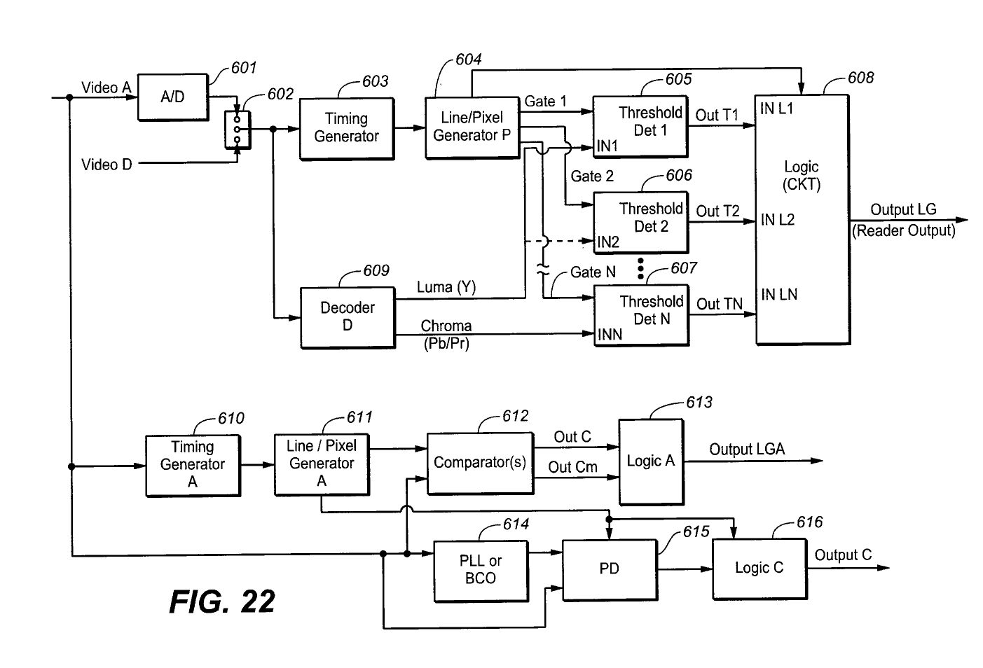

FIG. 22 is a block diagram of a reader or sensing system operating in accordance with the invention on an input video signal, either analog or digital and including largely conventional components except as indicated here. an input digital video signal VideoD (or the output of analog to digital converter 601) is coupled to a timing generator 603 via selection link 602. Decoder 609 receives a digital video stream selected from link 602. Decoder 609 typically decodes a composite TV signal (e.g., digitized from A/D converter 601) into component video signals such as R, G, B or Y, Pb, Pr. In some instances if the incoming digital signal is already in a format of component video signals, decoder 609 may be bypassed. The luma and/or chroma component signals are then coupled to a plurality of threshold detectors (e.g., detectors 605, 606, and 607) for sensing a particular portion of a digital video stream. Timing generator 603 extracts line and field/frame signals from the digital video signal to provide a horizontal and vertical rate reference signal, which is then coupled to generator circuit 604. Circuit 604 provides a gating signal for various locations of a video signal that will be examined for any content control signal or copy protection signal.

For example, signal Gate 1 may be coincident with selected lines and selected pixel portions in the vertical blanking interval. Thus, signal Gate 1 “windows” in a period or interval when pseudo sync and/or AGC pulses are present. Gate 1 is then coupled to detector 605, which is a threshold detector (e.g., set for above blanking level to detect AGC pulses or set to below blanking level to detect pseudo sync pulses in the luma or Y channel from decoder 609). The output of detector 605 is coupled to a logic circuit 608, which can then identify the presence of positive or negative going pulses in the video signal via identification signal Output LG. This identification signal provides a signal indicative of the location of the ACP signal (e.g., pulses—pseudo sync and/or AGC) and/or the number of such pulses per TV line. This identification may include the width or duration of each pulse that is sensed. (Generally a threshold detector may be implemented to include a digital comparator circuit.)

In a further example, signal Gate 2 may be coincident with the horizontal blanking interval (HBI), which may then allow threshold detector 606 to sense for positive or negative going pulses in a portion of the HBI for the luma or Y channel of decoder D 609.

In another example, the color signal Pb and/or Pr from decoder D 609 is coupled to threshold detector 607, with a Gate N signal coincident with a video back porch portion. If there is a color stripe signal or color burst modification (part or whole) present in the video, the decoded signal Pb and/or Pr will exhibit a signal level different from a normal phase color burst signal. Thus threshold detector 607 may then generate a signal indicative of an ACP color burst modification, and the output of detector 607 is coupled to logic circuit 608.

Logic circuit 608 (via its output signal LG) then indicates one or more of the following:

a positive and/or negative going signal in a portion of the video signal,

an added waveform in a portion of the video signal,

a phase change in color burst (e.g., a color stripe process or weakened or defeated color stripe process),

length of a color burst (modified or unmodified),

amplitude of a color burst,

pixel and/or line location of the a phase change of a color burst,

and/or number or color burst modifications per field or frame.

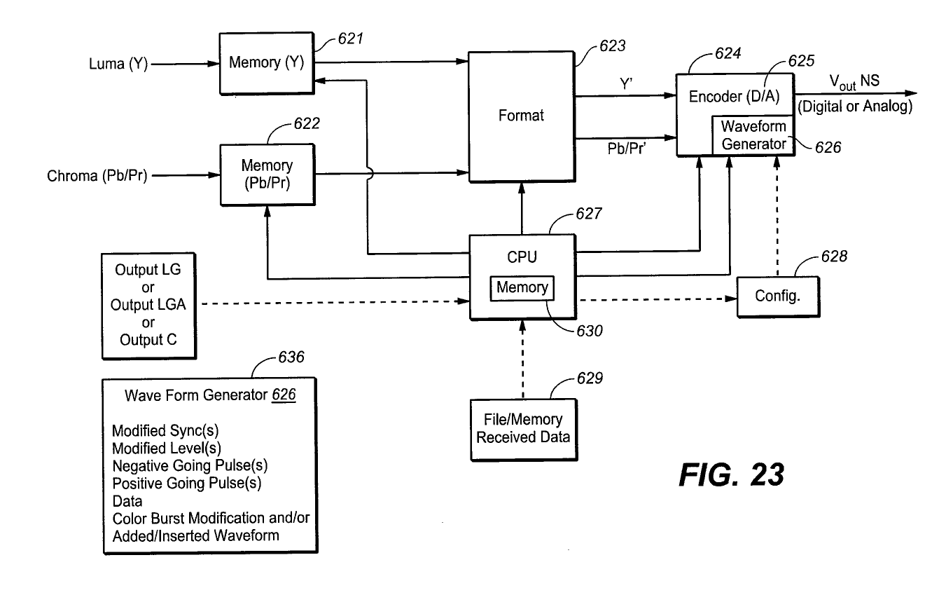

Circuit elements 605-608 allow up to N types of signals or modifications to a video signal to be identified or read. The output signal LG of logic 608 may then be coupled to a CPU or computational (or arithmetic) unit (see FIG. 23). For example, the CPU can determine a set of (received) ACP or content control signals (e.g., “f” in device 521, FIG. 14B); and then provide a set of ACP or content control signals (e.g., “g” in device 521) for a different TV standard, via circuit elements 626 or 628 or 629 of FIG. 23 and via the output of encoder 624 in FIG. 23.

Logic 608 may also include or have associate with it frequency and/or phase detectors (not shown) to sense waveforms of a selected frequency. In some cases one or more cycles of a particular frequency may be used for a content control signal, so sensing the one or more cycles in a frequency range is indicated in output LG of logic 608.

Circuit elements 605 to 608 of FIG. 22 may be coupled to the (input) digital video stream VideoA via selector 602 to read digital data such as APS bit(s), configuration bit(s), control bit(s), or any other data that represents a set of ACP or content control signals. This data can be then coupled to a CPU (see FIG. 23), which then allows a set of ACP or content control signals to be applied for a different TV standard. For example, such data or bits may be provided in a DVD's signal stream; or such bit(s) may be provided through a set top box's (or a mobile device's) control bits received (e.g., via transmission, cable, fiber, wireless, or the like) from the system operator, or bit(s) stored in a medium, or by data entry.

In some instance, content control signal(s), copy protection signal(s), data, and/or waveform modification may read or sensed in the analog domain from analog input Video A. Also sensing or reading may be done in any combination of analog and/or digital (or software) domain(s). In FIG. 22, analog video signal Video A is coupled to timing generator A 610, which then outputs horizontal and field/frame rate signals to line/pixel generator A 611. Line/pixel generator A 611 outputs a gating signal coincident to one or more signal modifications. For example generator 611 may output one or more signals that are logic high during a portion of the VBI (e.g., where pseudo sync/AGC pulses are inserted or added), and/or during a portion of the HBI (e.g., where a color stripe signal is added or inserted). Generator 611 then may be output a signal that is indicative modification(s) of one or more portions of the video signal.

In an example for sensing positive or negative going pulses, a gating signal for a portion of the VBI is coupled to enable comparator circuit 612 to output logic signal(s) Out C, Out Cm indicative of positive (e.g., data, CGMS, AGC, positive level shifted portion of a video signal, periodic waveform) or negative going pulses (e.g., pseudo sync pulses, lowered portion(s) of a video signal, period waveform) in a portion of the VBI. Logic circuit A 613 is coupled to receive these output signals from comparator 612 to provide one or more signals Output LGA indicative of content control and/or at least part of a copy protection signal. Logic A circuit 613 may also provide location (e.g., line, field/frame, and/or pixel location(s)), duration, and quantity of the one or more pulses/signals detected in its output signal Output LGA.

For color burst modification detection in an analog domain, the input analog VideoA signal is typically coupled to PLL 614, which may be a phase locked loop circuit (PLL) or a burst continuation oscillator (BCO) or equivalent (e.g., ringing circuit). The output of PLL 614 is a signal of an average phase of the color burst, which is coupled to phase detector 615. Phase detector 615 with the output of line/pixel generator A 611 provides a signal indicative of TV lines that have normal and/or non-normal phase. The output of phase detector 615 is coupled to logic circuit C 616, which provides an output signal Output C indicative of a color burst modification (color stripe). Logic C's output signal Output C may also indicate one or more of the following (see FIG. 9):

Duration of color burst

Number of color burst phase switch points

Number of non-normal color bursts or number of color burst modifications per duration (such as field or frame).

Location of TV lines which have a color burst modification

Type of the color stripe process

Duration of normal and/or non-normal phase portion(s) of the modified color burst

Absence or elongation of at least a portion of a color burst (which may be used for content control)

Note that the above are examples and other features of the modified color burst may be present and indicated such as frequency, modulation, and/or amplitude. It should be noted that all of these features may be present in the digital domain and signal Output LG from circuit 608 may include the types of signals in Output signal LGA from logic A 613 and/or Logic C 616, and vice versa.

Such a reader or detector may be programmable. The programmability of a reader or detector for multiple of TV standards (e.g., including HD format(s)), allows the identification of the content control signal, copy protection signal, or other modified signals that would be changed or updated.

FIG. 23 illustrates in a block diagram a scaler in accordance with the invention for converting one TV standard to another and used in conjunction with the reader device of FIG. 22 in some embodiments. Input video digitized luma and chroma signals are coupled to memory elements (such as registers) 621 and 622 respectively. Memory elements 621 and 622 store the video signal in component form in terms of pixels and lines. The output signal of elements 621 and 622 are coupled to a formatting or signal processing circuit 623 which typically includes circuits for decimation (e.g., for contracting a signal in time), and/or interpolation (e.g., for elongating a signal in time) applied to the input luma and chroma signals. The output of formatter 623 then provides pixels and lines for a new TV standard (indicated as Y′ and (Pb/Pr)′), which is coupled to circuit 624 (including encoder 625 and waveform generator 626). Encoder 625 typically inserts or adds the new sync signals appropriate to the new TV standard. If a composite signal or subcarrier signal is required, encoder 625 includes modulation circuitry for a generated subcarrier and a digital to analog converter. The optional digital to analog converter in encoder 624 provides an analog output signal in the form of composite, S-Video, and/or component video signal.

For the TV signal (of new standard) from encoder 625, waveform generator 626 adds or provides suitable copy control/copy protection signal modifications to the video signal of the new TV standard. Generator 626 may receive instructions from a configuration control system 628 which may have a preset or stored or data entered bits to command waveform generator 626 to provide one or more modifications in the new TV signal. An exemplary list of such modifications implemented by waveform generator 626 to the converted video signals is shown in Table 636.

Waveform generator 626 for example, generates AGC pulses (e.g., positive pulses) or other signals for the newly converted or scaled TV signal. CPU 627 with its memory 630 controls elements 621, 622, 623, 625, 626, and/or 628. CPU 627 receives information e.g. from the reader of FIG. 22 (the Output LG or LGA or Output C signals) for identifying a set of content control or copy protection signal(s) from the input video signal (e.g., the set of ACP or content control signals from “f” in apparatus 521 of FIG. 14B).

CPU 627 may then assign a (new) set of content control or copy protection signals for the newly scaled TV signal. The assignment of a set of ACP or content control signals for “g” in apparatus 521 of FIG. 14B, may (for example) be preprogrammed according to the final TV standard that is scaled to, and/or be based on the output of the reader (e.g., elements 608 or 613 or 616 of FIG. 22).

In another example, control bits stored in memory element 629 and received from a storage device or receiver (not shown) determine the type of content control or copy protection signals to be assigned for the new TV standard. For example, a DVD player or set top box may receive a file stored in memory 629 pertaining to the type of content control signals to be applied (e.g., to apply a set ACP or content control signals found in the “g” function of 521 of FIG. 14B) for a new TV standard. This file may be input to the CPU 627, which stores the file in memory 630, and which the CPU 627 sends to the waveform generator 626 to provide the content control and/or copy protection signals for the new TV standard.

CPU 627 also selects/controls the output video TV format or standard. Signal VoutNS from encoder 625 is then a new video standard TV signal with a set of content control and/or copy protection signal(s). Signal VoutNS is for example a composite, component, or S-Video signal, or a digital video signal. Configuration element 628 (controlled by CPU 628) represents an alternative way (indicated by the broken lines) to select the various waveforms for generator 626 via an on/off mode and/or APS bits (one or more types of analog protection signals) or configuration (e.g., limited configuration of the various waveforms such as fixed amplitudes of pseudo sync, AGC, color stripe, etc.).

In some cases generator 626 is flexible in terms of providing any modification for signal VoutNS in terms of content control, data, and/or copy protection signal(s), such as via CPU 627. Such waveform generation includes modifying any part of the video signal down to the pixel level.

The devices or methods described here may be embodied conventionally in any combination of analog circuitry, digital circuitry, and/or software implementation(s). The devices or apparatuses may be enabled or disabled or configured via one or more bits or signals. Furthermore the circuitry (e.g., such as in an integrated circuit) may be disconnected or disabled via program software or use of fusable link(s). Also a memory or storage device may be included. Also an RF (radio frequency) device may be included to operate as e.g. a tuner, modulator, or output stage. Designing and making such devices would be routine in light of this disclosure.

This disclosure is illustrative and not limiting. Further modifications will be apparent to those skilled in the art in light of this disclosure, and are intended to fall within the scope of the appended claims.

We claim:

1. A method of converting a video signal, comprising the acts of:
receiving a video signal conforming to a first standard and including content control information;
converting the received video signal to conform to a second standard;
including in the converted video signal content control information corresponding to that in the received video signal; and
outputting the converted video signal with the corresponding content control information.

2. The method of claim 1, wherein the copy control information in the output video signal is one of a flag, control bits, modification signals, pseudo sync pulses, color burst modification, AGC pulses, back porch pulses, altered sync pulses, modification signals or tri-level sync pulses.

3. The method of claim 1, wherein the second standard is one of NTSC, PAL, SECAM, VGA or HDTV.

4. The method of claim 3, where the second standard is HDTV and the first standard is HDTV, and the first and second standards differ in terms of progressive or interlaced scan, or number of lines of resolution.

5. A device configured to carry out the method of claim 1, wherein the device is a scaler, transcoder, encoder or converter.

6. The method of claim 1, wherein the copy control information in the output video signal carries the same content control effect as the content control information in the received video signal.

7. Apparatus for converting a video signal, comprising:
an input terminal adapted to receive a video signal conforming to a first standard;
a video converter coupled to the input terminal and that converts the received video signal to a second standard;
a detector coupled to the input terminal and that detects content control information;
a content control logic coupled to the detector and that generates content control information for the second standard and corresponding to that detected;
a combiner coupled to the detector and converter and combining the generated content control information with the converted video signal; and
an output terminal coupled to the combiner.

8. The apparatus of claim 7, wherein the copy control information in the video signal output from the apparatus is one of a flag, control bits, modification signals, pseudo sync pulses, color burst modification, AGC pulses, back porch pulses, altered sync pulses, modification signals or tri-level sync pulses.

9. The apparatus of claim 7, wherein the second standard is one of NTSC, PAL, SECAM, VGA or HDTV.

10. The apparatus of claim 9, where the second standard is HDTV and the first standard is HDTV, and the first and second standard differ in terms of progressive or interlaced scan, or number of lines of resolution.

11. The apparatus of claim 7, wherein the apparatus is one of a scaler, transcoder, encoder or converter.

12. The apparatus of claim 7, wherein the copy control information in the video signal output from the apparatus carries the same content control effect as the content control information in the received video signal.

13. A method of processing a video signal, comprising the acts of:
receiving a video signal conforming to a first standard and including content control information;
detecting the content control information;
generating content control information for a second standard corresponding to that in the received video signal; and
outputting the corresponding content control information.

14. The method of claim 1, wherein the output copy control information is one of a flag, control bits, modification signals, pseudo sync pulses, color burst modification, AGC pulses, back porch pulses, altered sync pulses, modification signals or tri-level sync pulses.

15. The method of claim 1, wherein the second standard is one of NTSC, PAL, SECAM, VGA or HDTV.

16. The method of claim 3, where the second standard is HDTV and the first standard is HDTV, and the first and second standards differ in terms of progressive or interlaced scan, or number of lines of resolution.

17. A device configured to carry out the method of claim 1, wherein the device is a reader, detector or decoder.

18. The method of claim 1, wherein the output copy control information carries the same content control effect as the content control information in the received video signal.

19. Apparatus for processing a video signal, comprising:
an input terminal adapted to receive a video signal conforming to a first standard;
a detector coupled to the input terminal and that detects content control information in the video signal;
a content control logic coupled to the detector and that generates content control information for a second standard and corresponding to the detected content control information; and
an output terminal coupled to the logic to output the generated content control information.
